(19) United States
(12) Patent Application Publication
(10) Pub. No.: US 2016/0336826 A1
(43) Pub. Date: Nov. 17, 2016

(54) STATOR AND DYNAMO-ELECTRIC MACHINE EQUIPPED WITH SAME

(71) Applicant: KOMATSU LTD., Tokyo (JP)

(72) Inventors: Kouhei ICHIKAWA, Hirakata-shi, Osaka (JP); Hitoshi NAKAGAWA, Ikoma-shi, Nara (JP); Shinya KANOU, Shimamoto-Town, Osaka (JP); Mutsuo KOGA, Hirakata-shi, Osaka (JP); Akira MINAMIURA, Hiratsuka-shi, Kanagawa (JP)

(21) Appl. No.: 15/109,495

(22) PCT Filed: Mar. 25, 2015
(86) PCT No.: PCT/JP2015/059252

§ 371 Date: Jul. 1, 2016

(30) Foreign Application Priority Data
Mar. 27, 2014 (JP) PCT/JP2014/059022

(51) Int. Cl. H02K 3/28; H02K 3/12; H02K 1/16

(52) U.S. Cl. CPC H02K 3/28; H02K 1/16; H02K 3/12

(57) ABSTRACT

Conductor segments that form a coil in a stator are formed by rectangular wires and are disposed in slots such that wide first faces are parallel to the radial direction. A plurality of conductor segments are disposed in the slots so that narrow second faces are opposite each other. The conductor segment disposed at the i-th (where i is an integer greater than or equal to 1) position from the inside of a stator core is joined to the conductor segment disposed in the (i+1)-th position in another slot such that vertical parts and horizontal parts thereof are opposite each other. The joined opposing first faces are formed parallel to the radial direction and are provided on both a first protrusion side and a second protrusion side.

### CROSS-REFERENCE TO RELATED APPLICATIONS

This application is a U.S. National stage application of International Application No. PCT/JP2015/059252, filed on Mar. 25, 2015, which claims priority to International Application No. PCT/JP2014/059022, filed in Japan on Mar. 27, 2014, the entire contents of which are hereby incorporated herein by reference.

### BACKGROUND

1. Field of the Invention

The present invention relates to a stator and to a dynamo-electric machine equipped with this stator.

2. Description of the Related Art

Recent years have seen the advent of hybrid vehicles and the like, and may drive motors are used for this purpose. Proposals for how to manufacture such a motor have included a method in which U-shaped conductor segments are inserted into slots and then the ends of the conductor segments are joined. A dynamo-electric machine manufactured by this method has also been proposed. (See Japanese Laid-Open Patent Application 2013-169037, for example.)

### SUMMARY

The following problem is encountered with the above-mentioned conventional dynamo-electric machine and method for manufacturing a dynamo-electric machine.

With the above-mentioned conventional dynamo-electric machine, to ensure adequate joint strength, after the U-shaped conductor segments have been inserted into the slots, the ends of the conductor segments are compressed, but performing this compression can be difficult when the joined ends are very close together.

When a plurality of conductor segments are disposed in a single slot (more than with Japanese Laid-Open Patent Application 2013-169037), it is difficult to perform the compression because the ends to be joined are even closer together, and it is difficult to provide a dynamo-electric machine in which sufficient joint strength is ensured.

The present invention was conceived in light of the above problem, and it is an object thereof to provide a stator with which sufficient joint strength can be ensured even if the portions to be joined are close together, as well as a dynamo-electric machine in which this stator is used.

The stator pertaining to a first exemplary embodiment of the present invention comprises a stator core and a coil. The stator core is cylindrical and has a plurality of slots formed in the radial direction on its inside. The coil has a plurality of conductor segments disposed in the slots and is formed by joining the ends of the conductor segments. The conductor segments are formed by rectangular wires that are rectangular in cross section and have a wide first face and a narrow second face, and are disposed in the slots so that the first faces are parallel to the radial direction. A plurality of the conductor segments are disposed in the slots so that the respective second faces are opposite each other. The conductor segment disposed at the i-th (where i is an integer greater than or equal to 1) position from the inside of the stator core is joined to the conductor segment disposed at the (i+1)-th position in another slot such that the first faces are opposite each other at the respective ends. The joined opposing first faces are formed parallel to the radial direction. The term “parallel” as used in this

Specification does not mean only parallel in the strict sense. Variance can be caused by mechanical working, bending, and assembly of the constituent parts, so the word parallel will be used for the purpose of description in this application even though it may not necessarily fit the precise geometric definition.

Since the conductor segments are thus joined at the wider first faces, adequate joint strength can be ensured even if welding is performed without compressing the ends of the conductor segments together.

Since there is no need to compress the ends of the conductor segments, a stator with which adequate joint strength can be ensured can be provided even if the portions to be joined are close together.

The joined portions also need to have the same cross sectional area as the conductor segments in order to obtain good strength and conductivity, but since the wide first faces are opposite each other in this joining, the joint depth need should be equivalent to the width of the second faces, so the height of the coil end part can be kept low.

The stator pertaining to a second exemplary embodiment of the present invention is the stator pertaining to the first exemplary embodiment of the present invention, wherein the end of the i-th conductor segment is joined to the end of the (i+1)-th conductor segment by being bent outward toward the end of the (i+1)-th conductor segment so that the second face curves.

Consequently, the joined first faces are formed toward the outside of the stator core. In the manufacture of the stator, the position of the ends of the conductor segments to be joined is toward the outside of the stator core.

In the welding of the ends of the conductor segments, wedge-shaped welding electrode is inserted from the outer peripheral side of the stator into the outside in the peripheral direction of two ends disposed opposite each other, in order to maintain a state in which the ends of two conductor segments to be joined are in contact with each other.

Here, when the position of two ends to be joined is toward the outside of the stator core, there will be a wider gap between the planned joining positions that are adjacent in the peripheral direction, so insertion of a jig will be easier, and it will also be easier to manufacture the welding electrodes because there is no need for their tips to be extremely tapered.

The stator pertaining to a third exemplary embodiment of the present invention is the stator pertaining to the first or second exemplary embodiments of the present invention, wherein the opposing first faces are the first face of the i-th conductor segment on the slot side where the (i+1)-th conductor segment is disposed, and the first face of the (i+1)-th conductor segment on the slot side where the i-th conductor segment is disposed.

Consequently, it is possible to join the conductor segments at a shorter distance.

The stator pertaining to a fourth exemplary embodiment invention is the stator pertaining to the second exemplary embodiment of the present invention, wherein a step is formed at the first face at the end of the i-th conductor segment so that the second face is narrower. The step face formed perpendicular to the first face by the step is disposed perpendicular to the radial direction, and the second face on the inside of the (i+1)-th conductor segment hits this step face. Variance can be caused by mechanical working, bending, and assembly of the constituent parts, so the word parallel will be used for the purpose of description in this application even though it may not necessarily fit the precise geometric definition.

As discussed above, when a wedge-shaped welding electrode has been inserted, the two ends to be joined are pushed in the radial direction to the inside of the stator core, but when a step is formed at the end of the i-th conductor segment, the end of the (i+1)-th conductor segment will be pressed against the step face of the i-th conductor segment, so welding can be performed more reliably. The step serves as a stopper when the (i+1)-th conductor segment moves to the inside.

The stator pertaining to a fifth exemplary embodiment of the present invention is the stator pertaining to the first exemplary embodiment of the present invention, wherein the conductor segments have in-slot portions disposed in the slots, first protrusions that protrude from a first end face (out of the two end faces of the stator core), and second protrusions that protrude from a second end face (out of the two end faces). The ends are provided to both the first protrusions and the second protrusion, and contact faces are provided on both the first protrusion side and the second protrusion side.

Thus, the ends of the conductor segments are formed at portions protruding form both end faces of the stator core, and are joined to other conductor segments at these ends. The conductor segments are not formed so as to go across two or more slots, and are instead disposed in only one slot each.

Consequently, the conductor segments can be inserted into the slots from the inside of the stator core even after bending has been performed. Since there is no need to perform the bending after the conductor segments have been inserted, the job can be carried out more easily.

The stator pertaining to a sixth exemplary embodiment of the present invention is the stator pertaining to the first exemplary embodiment of the present invention, wherein four or more of the conductor segments are disposed in each of the slots so that the second faces are opposite each other, and a plurality of the joined opposing first faces are disposed in the radial direction.

Thus, there is no need to perform compression even when a plurality of paired ends that are to be joined are provided in the radial direction, so welding can be performed that will ensure sufficient joint strength.

The stator pertaining to a seventh exemplary embodiment of the present invention is the stator pertaining to the fifth exemplary embodiment of the present invention, wherein a gap is formed between the first protrusion of the i-th conductor segment and the first protrusion of the (i+1)-th conductor segment, as viewed in the peripheral direction of the stator core, and a gap is formed between the second protrusion of the i-th conductor segment and the second protrusion of the (i+1)-th conductor segment, as viewed in the peripheral direction.

This makes it easier to insert an insulating sheet between gaps. It also ensures adequate gaps, making it easier to ensure good insulation.

The stator pertaining to an eighth exemplary embodiment of the present invention is the stator pertaining to the fifth exemplary embodiment of the present invention, wherein the end of the (i+1)-th conductor segment is bent inward toward the end of the i-th conductor segment so that the second face curves, and is joined to the end of the i-th conductor segment. The end of the (i+2)-th conductor segment is bent outward toward the end of the (i+3)-th conductor segment so that the second face curves, and is joined to the end of the (i+3)-th conductor segment.

For example, when i is 1, the second conductor segment is bent so that its end faces inward in the radial direction, and the third conductor segment is bent so that its end faces outward in the radial direction. Therefore, the welding of the first conductor segment and the second conductor segment can be performed from the inside in the radial direction of the stator core, and the welding of the third conductor segment and the fourth conductor segment can be performed from the outside in the radial direction of the stator core.

Since welded portions can thus be formed on the inside and outside in the radial direction of the stator core, the overall height of the stator can be kept low.

The dynamo-electric machine pertaining to a ninth exemplary embodiment of the present invention, comprising the stator according to any of the first to eighth exemplary embodimetns of the present invention, and a rotor disposed on the inside of the stator.

Consequently, a dynamo-electric machine can be obtained which is equipped with a stator that allows sufficient joint strength to be ensured.

The exemplary embodiments of the present invention provide a stator with which sufficient joint strength can be ensured even when the portions to be joined are close together, as well as a dynamo-electric machine in which this stator is used.

### BRIEF DESCRIPTION OF DRAWINGS

FIG. 1 is an oblique view of the dynamo-electric machine pertaining to a first exemplary embodiment of the present invention;

FIG. 2 is a diagram of the internal structure of the dynamo-electric machine in FIG. 1;

FIG. 3 is an oblique view of the stator in the dynamo-electric machine in FIG. 1;

FIG. 4 is a plan view of the stator core of the stator in FIG. 3;

FIG. 5 is an oblique view of U-phase coil components in the stator in FIG. 3;

FIG. 6A is an oblique view of the rectangular wire that forms the U-phase coil components in

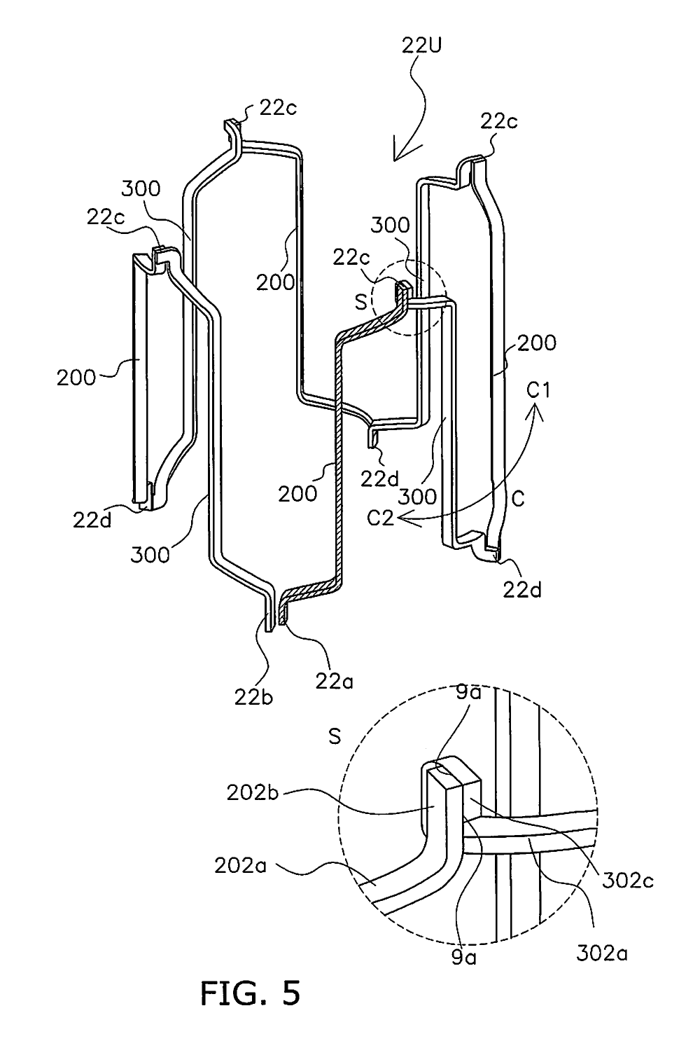

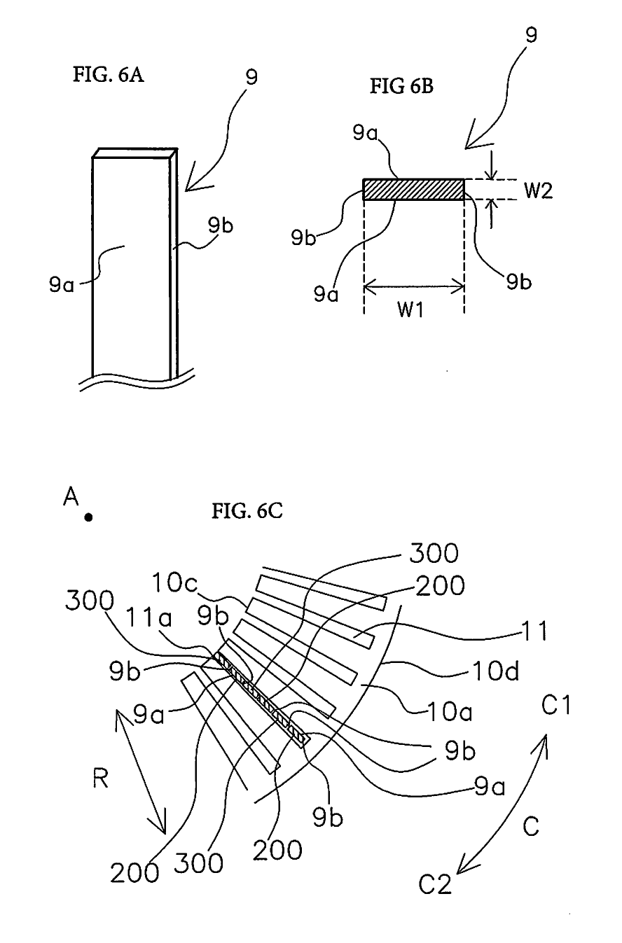

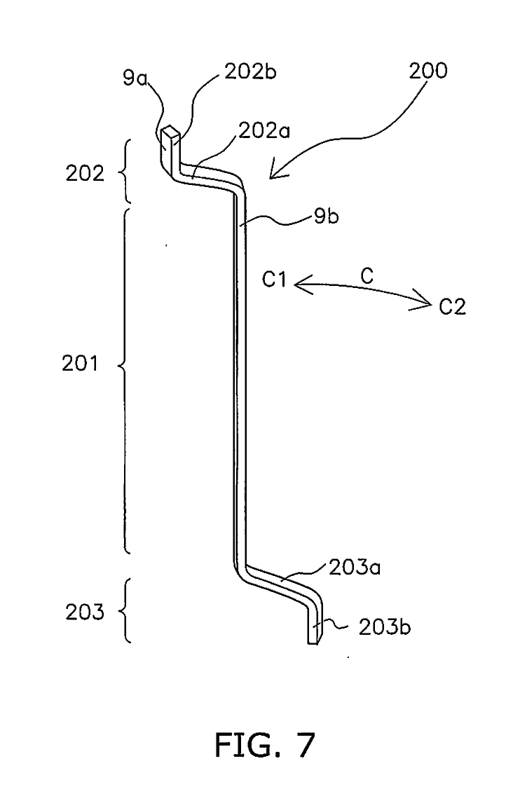

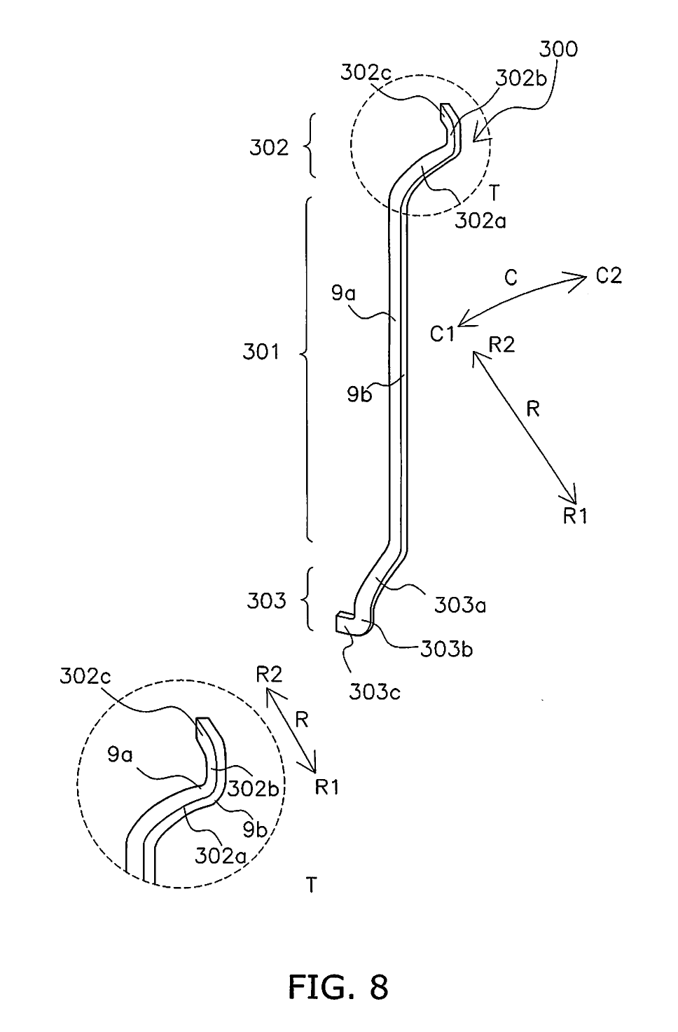

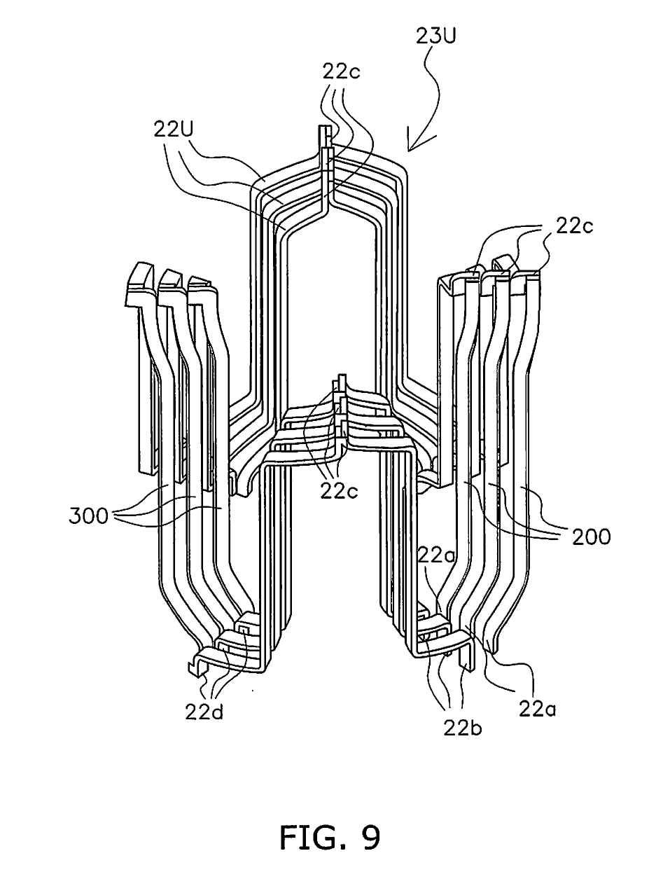

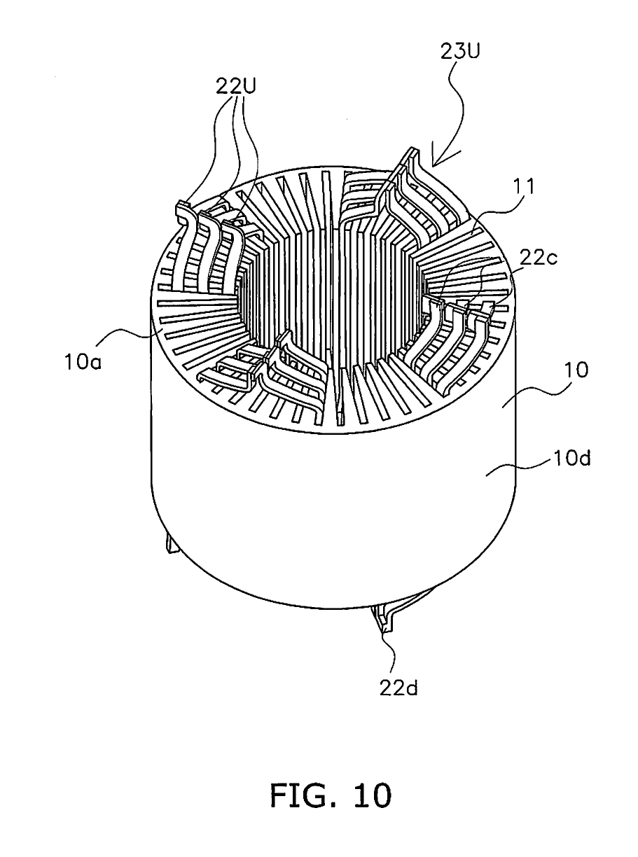

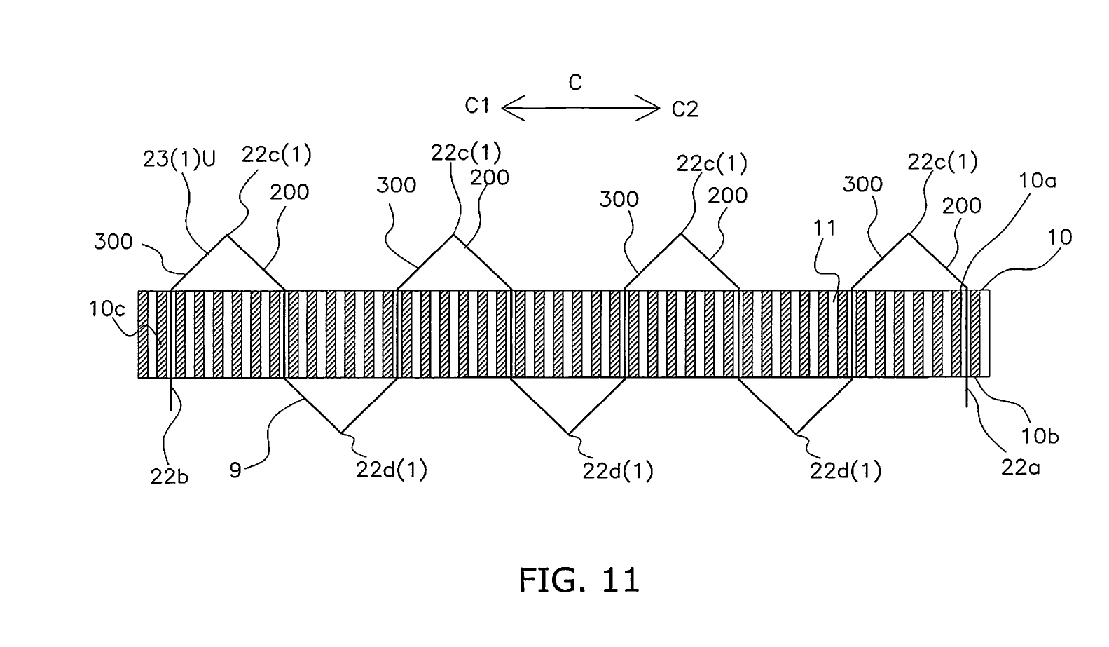

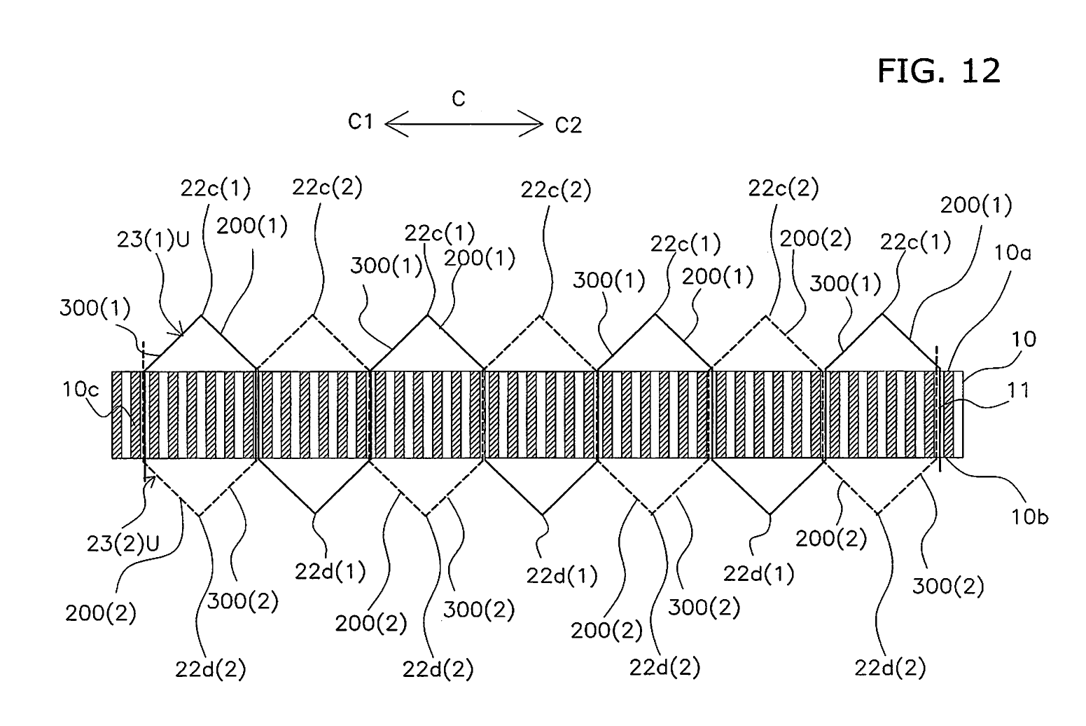

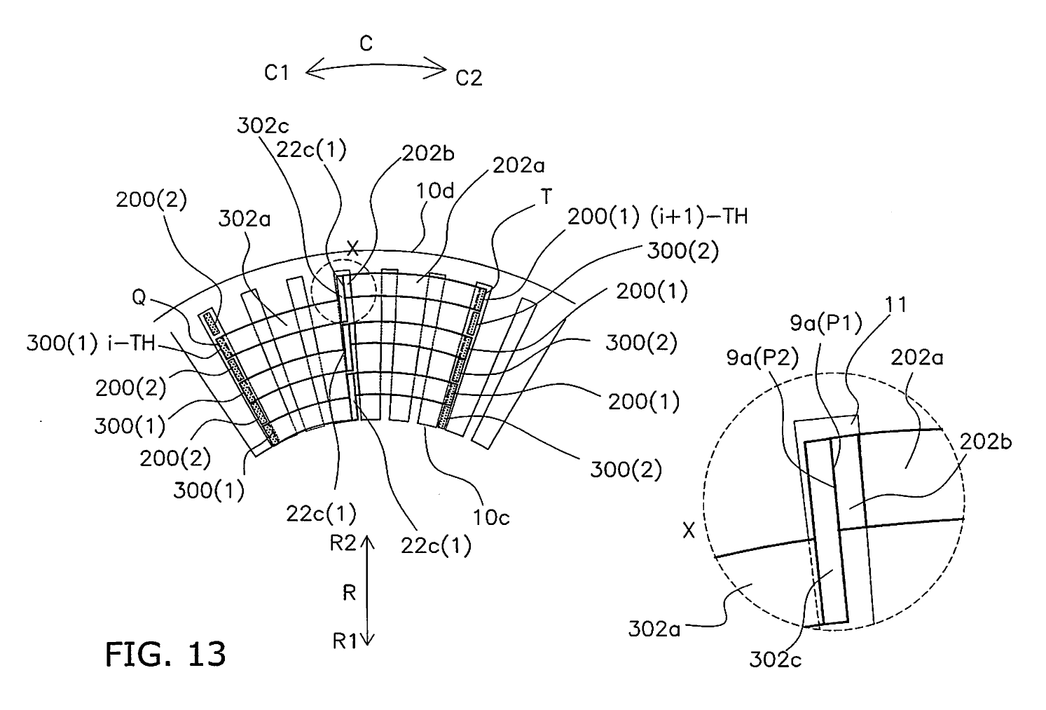

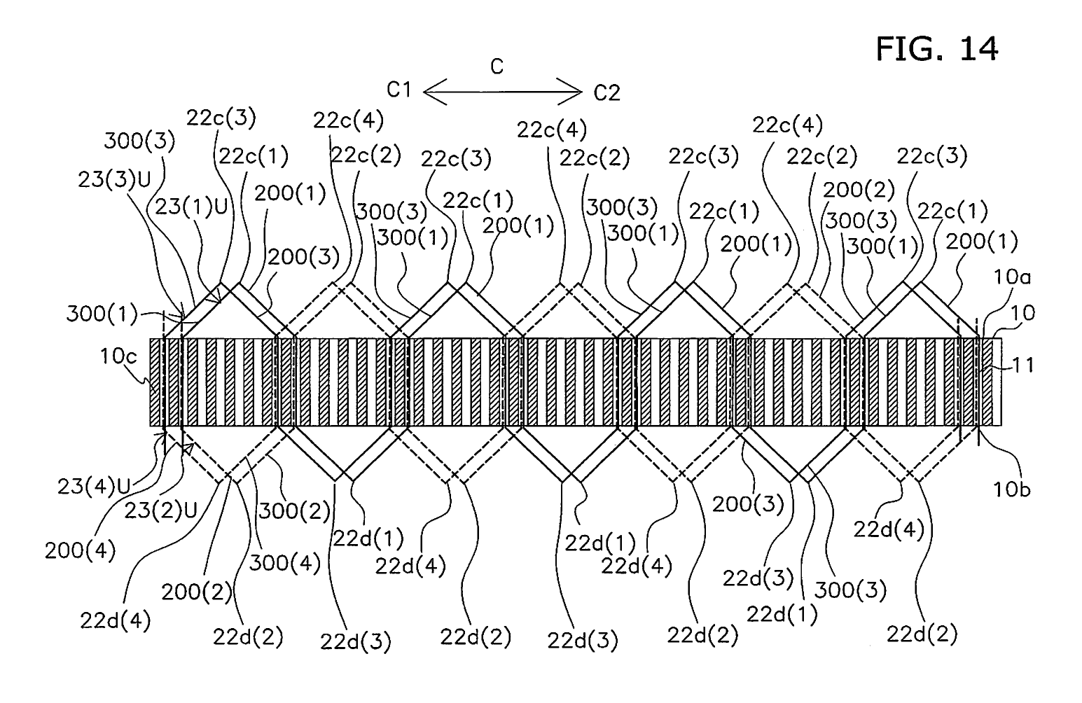

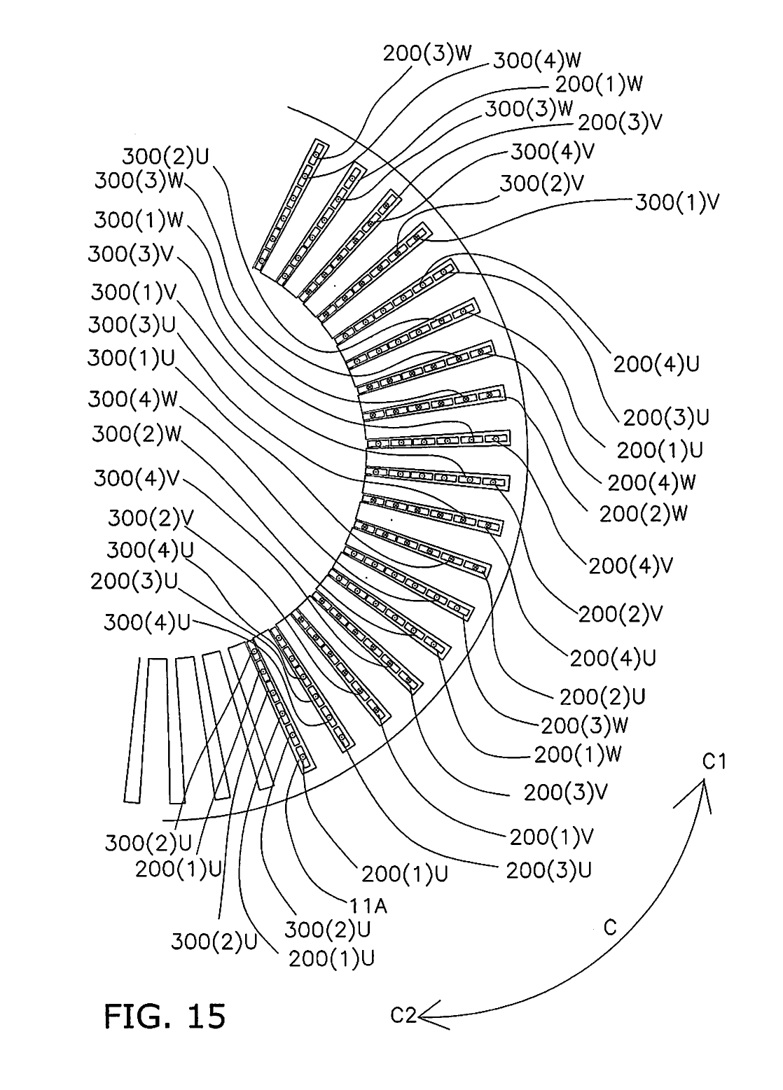

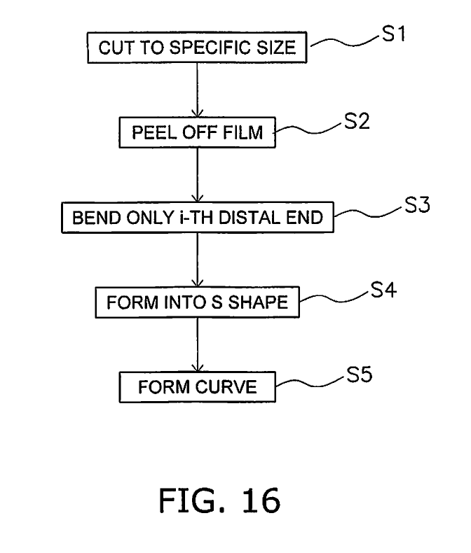

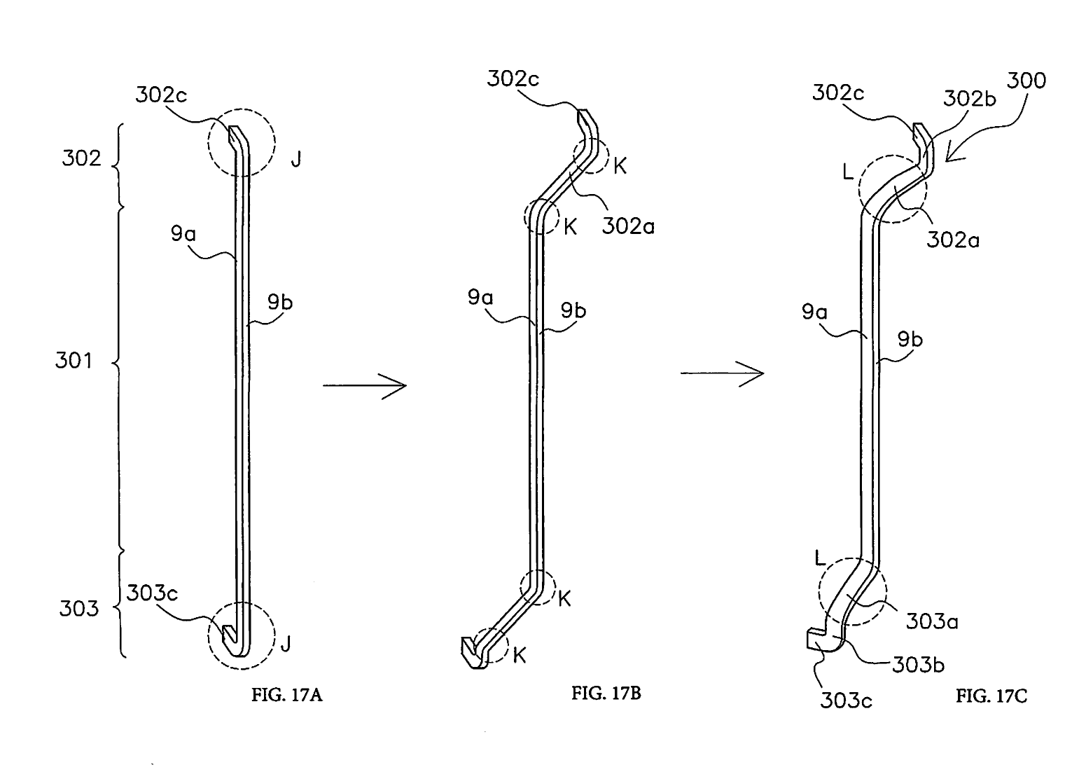

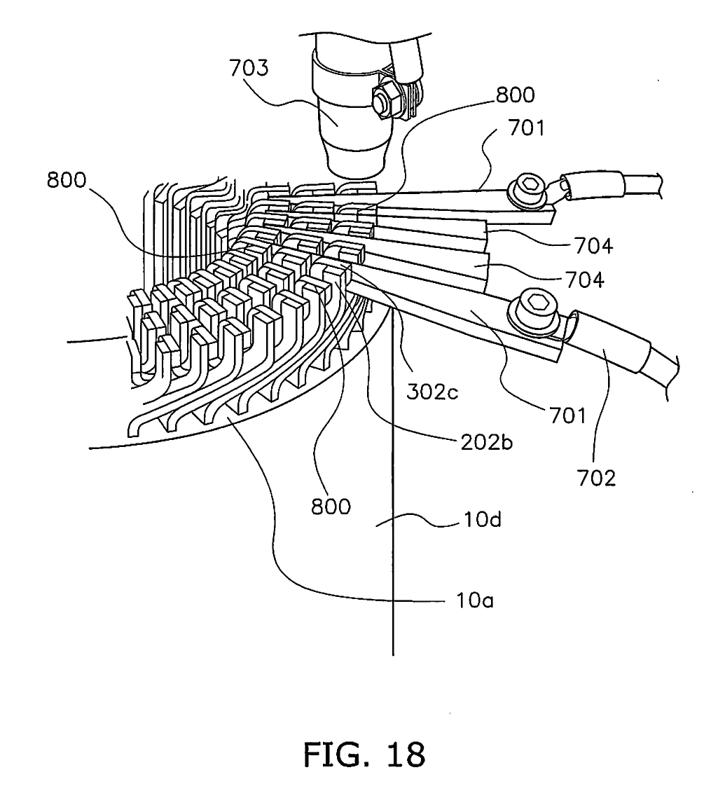

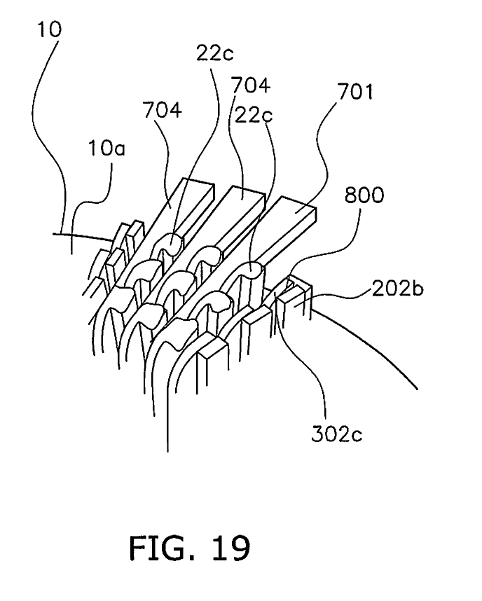

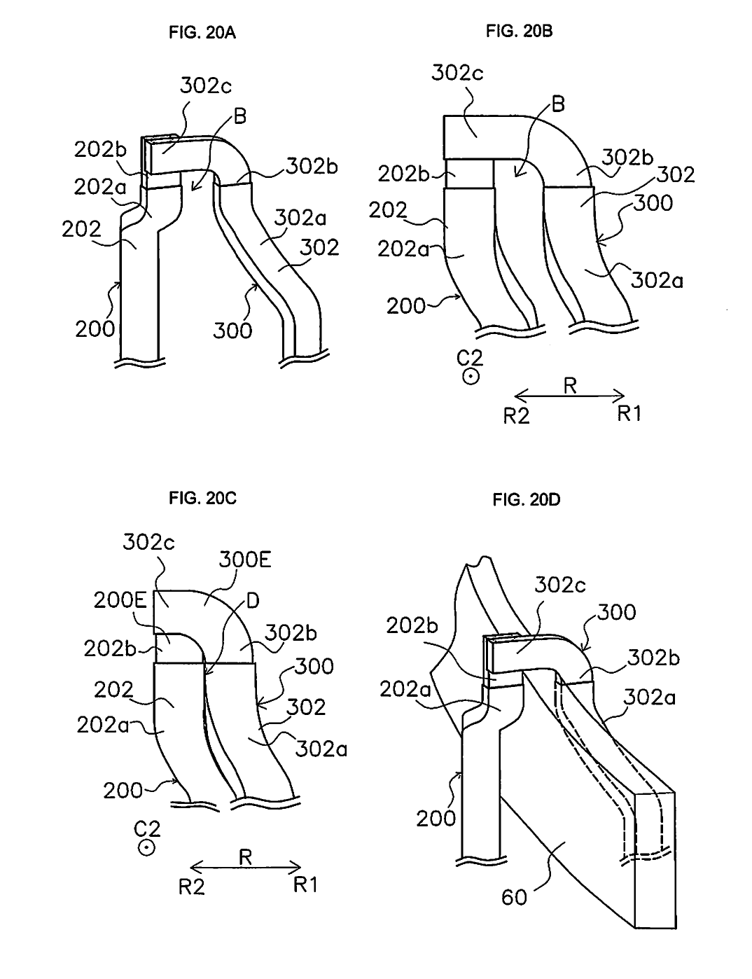

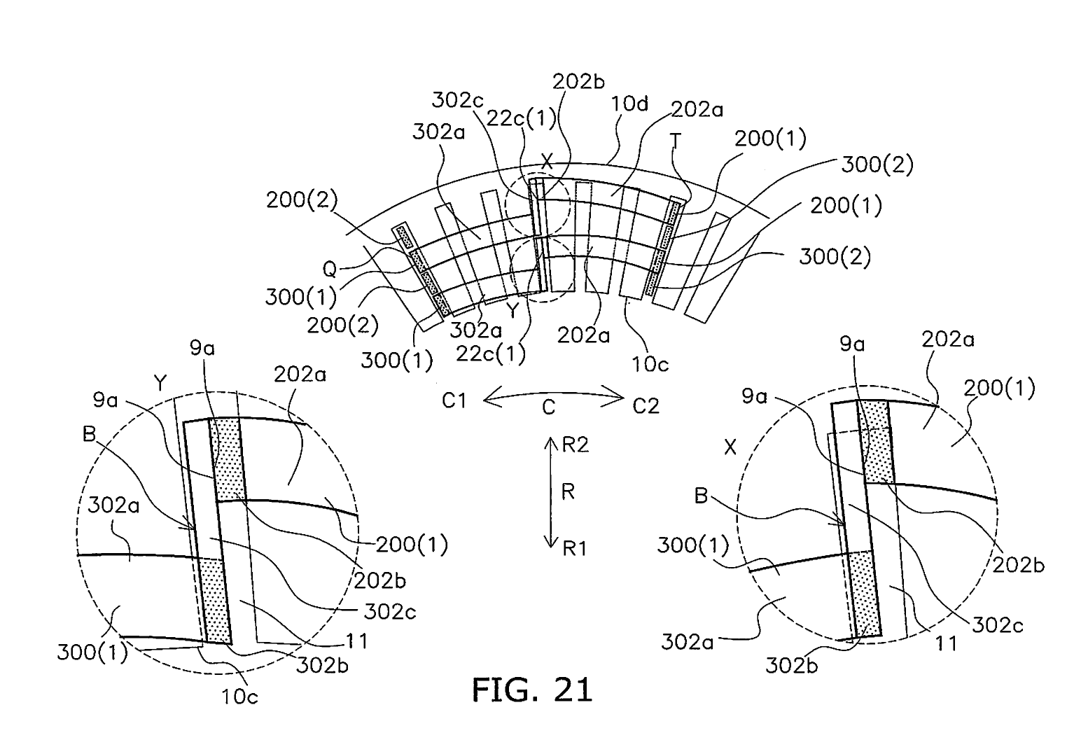

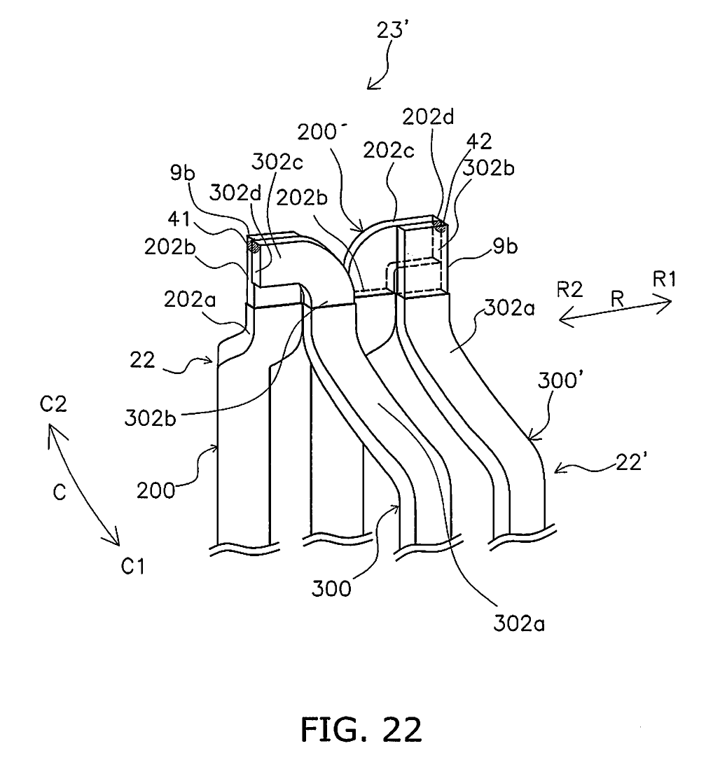

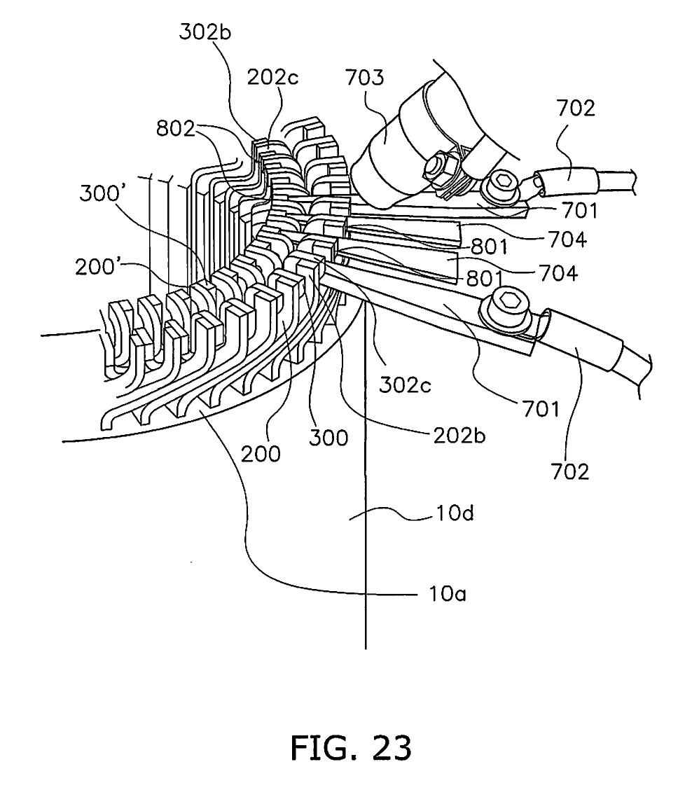

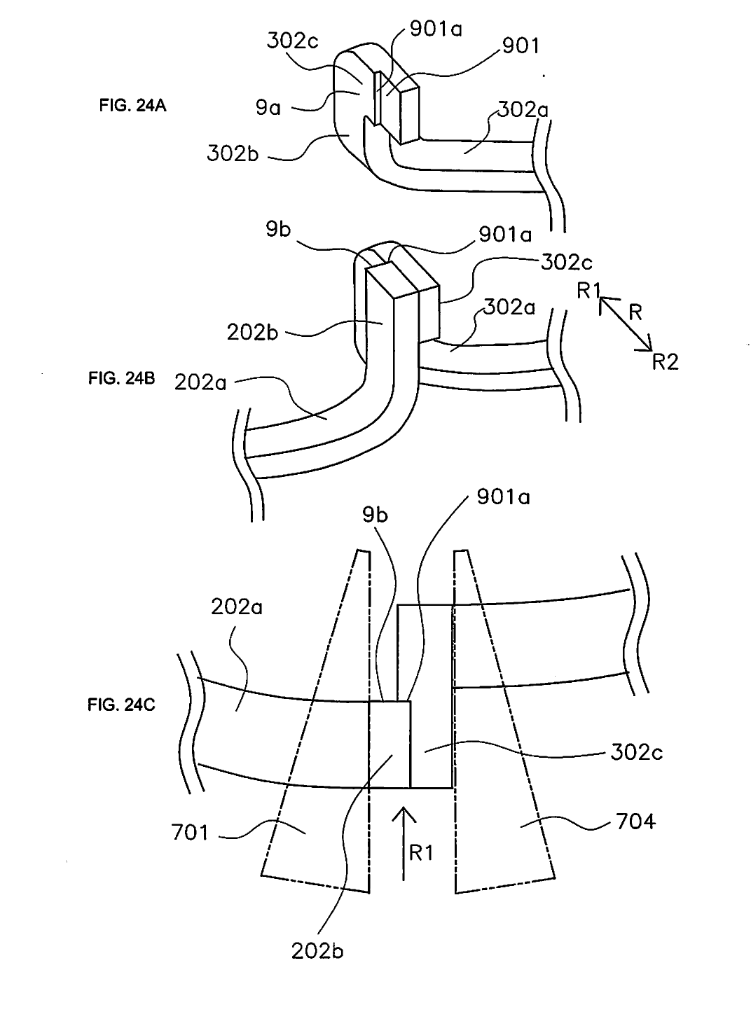

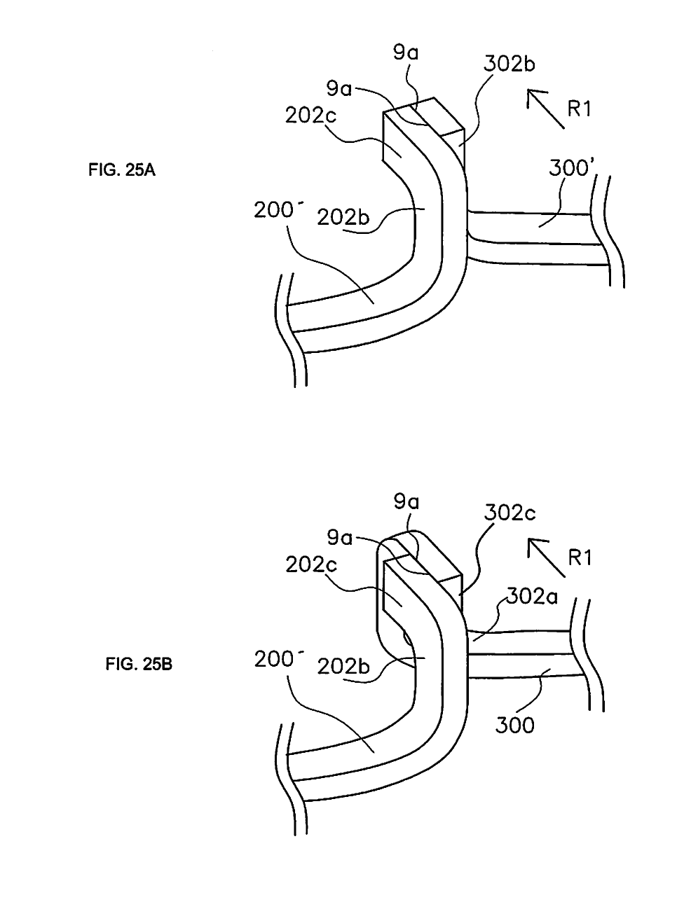

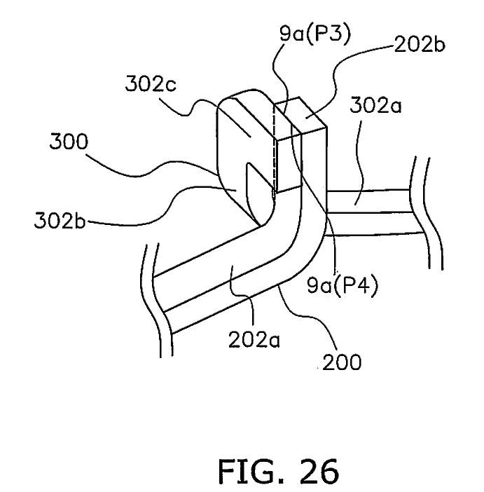

FIG. 5, FIG. 6B is a plan view of the rectangular wire in FIG. 6A, and FIG. 6C is a plan view of the rectangular wire shown in FIG. 6A being disposed in a slot;

FIG. 7 is an oblique view of a conductor segment of the U-phase coil components in FIG. 5;

FIG. 8 is an oblique view of a conductor segment of the U-phase coil components in FIG. 5;

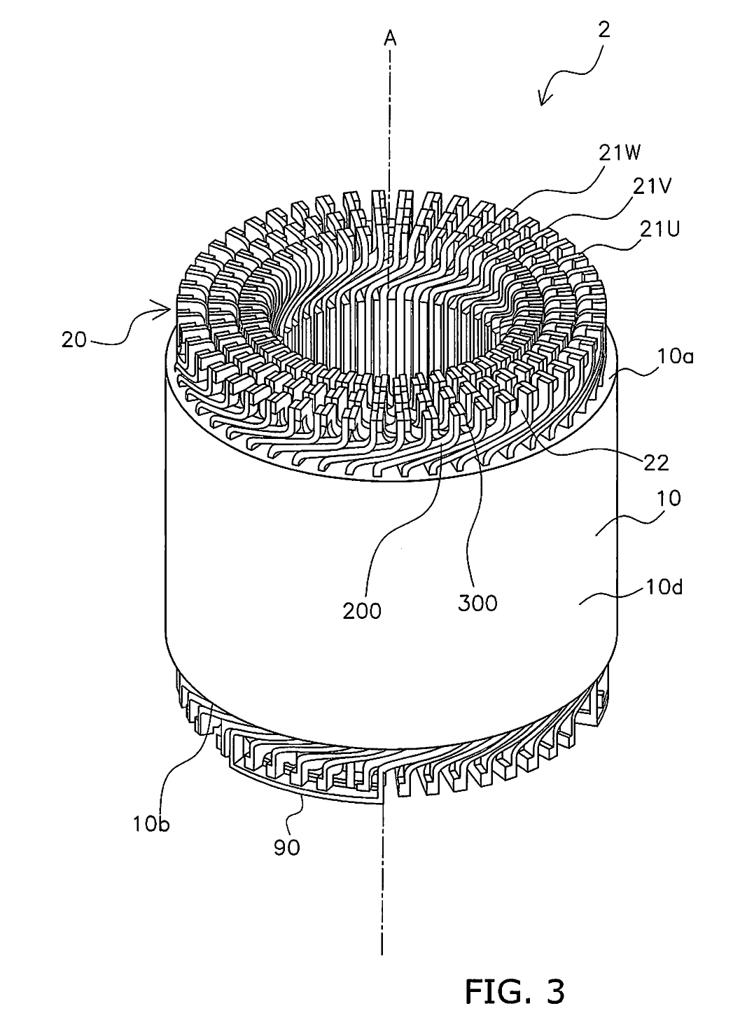

FIG. 9 is an oblique view of a U-phase coil component set of the stator in FIG. 3;

FIG. 10 is an oblique view of the U-phase coil component set and stator core of the stator in FIG. 3;

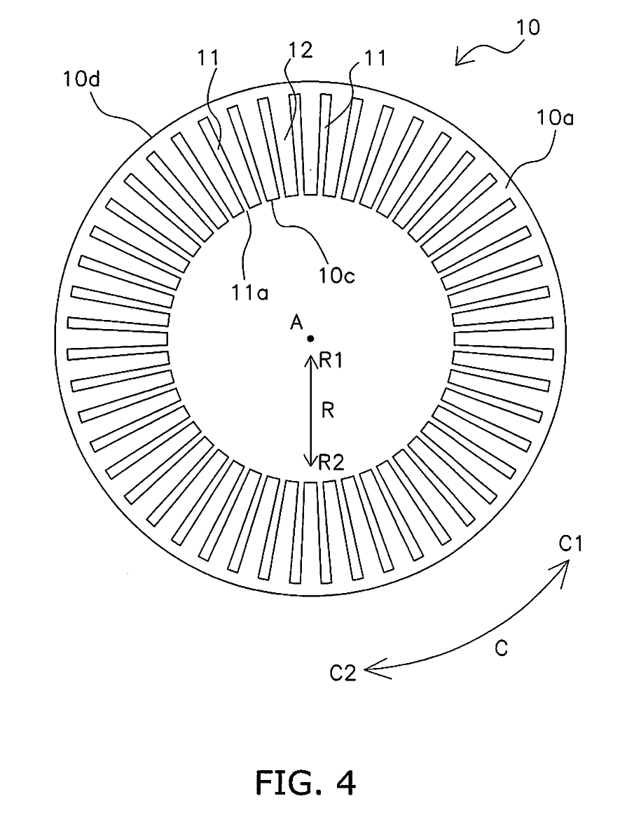

FIG. 11 is a schematic planar view of the state when one U-phase coil component set has been disposed in the stator core in FIG. 4;

FIG. 12 is a schematic planar view of the state when two U-phase coil component sets have been disposed in the stator core in FIG. 4;

FIG. 13 is a plan view illustrating the joining of the conductor segment in FIG. 7 with the conductor segment in FIG. 8;

FIG. 14 is a schematic planar view of the state when four U-phase coil component sets have been disposed in the stator core in FIG. 4;

FIG. 15 is a plan view illustrating the disposition of conductor segments of each phase in the stator shown in FIG. 3;

FIG. 16 is a flowchart of the steps for forming the conductor segment in FIG. 7 and the conductor segment in FIG. 8;

FIGS. 17A, 17B, and 17C are diagrams illustrating the formation of the conductor segment in FIG. 8;

FIG. 18 is an oblique view illustrating the welding of the conductor segment in FIG. 7 and the conductor segment in FIG. 8;

FIG. 19 is an oblique view of the state after the welding of the conductor segment in FIG. 7 and the conductor segment in FIG. 8;

FIG. 20A is an oblique view of the area near the joined portion of the conductor segment in a second exemplary embodiment pertaining to the present invention, FIG. 20B shows the area near the joined part of the conductor segment shown in FIG. 20A as seen in the peripheral direction, FIG. 20C shows the area near the joined part of the conductor segment in the first exemplary embodiment pertaining to the present invention as seen in the peripheral direction, and FIG. 20D shows the area near the joined part of the conductor segment in the second exemplary embodiment pertaining to the present invention;

FIG. 21 is a plan view of the connection relationship between the conductor segments shown in FIG. 20A;

FIG. 22 shows the area near the joined portion of the conductor segment in a third exemplary embodiment pertaining to the present invention;

FIG. 23 is an oblique view of the state when the conductor segments shown in FIG. 22 are welded together;

FIG. 24A is a diagram of the conductor segment in a modification example of an exemplary embodiment pertaining to the present invention, FIG. 24B is a diagram of the joined portion using the conductor segment shown in FIG. 24A, and FIG. 24C is a plan view of FIG. 24B;

FIGS. 25A and 25B show the joined portion using the conductor segment in a modification example of an exemplary embodiment pertaining to the present invention; and

FIG. 26 is a diagram of the joined portion using the conductor segment in a modification example of an exemplary embodiment pertaining to the present invention.

### DETAILED DESCRIPTION OF EXEMPLARY EMBODIMENTS

The stator and dynamo-electric machine pertaining to an exemplary embodiment of the present invention will now be described through reference to the drawings.

### First Exemplary Embodiment

1. Configuration

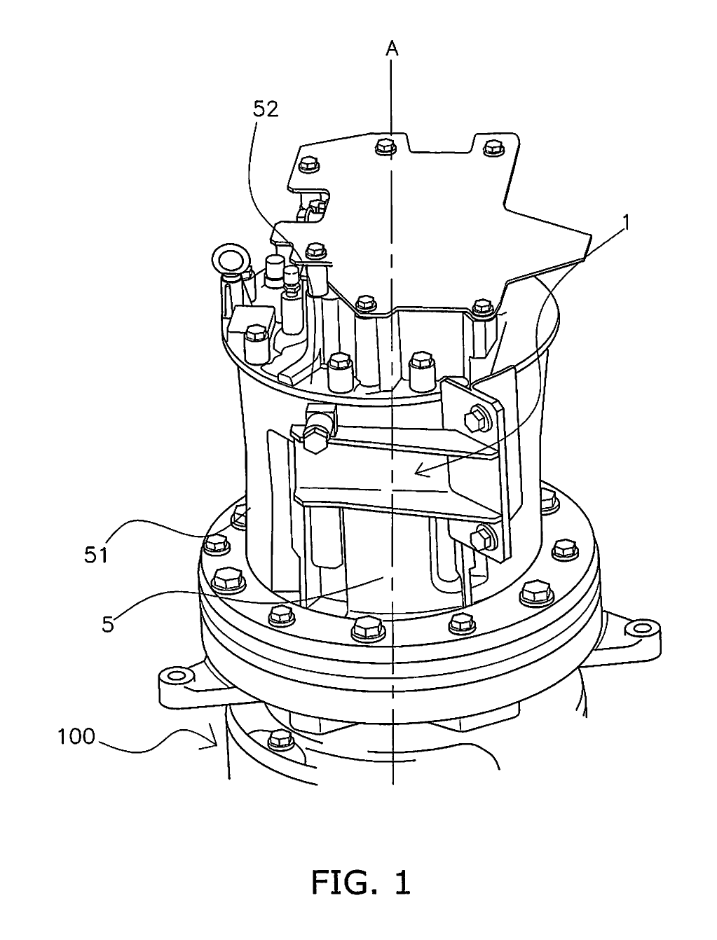

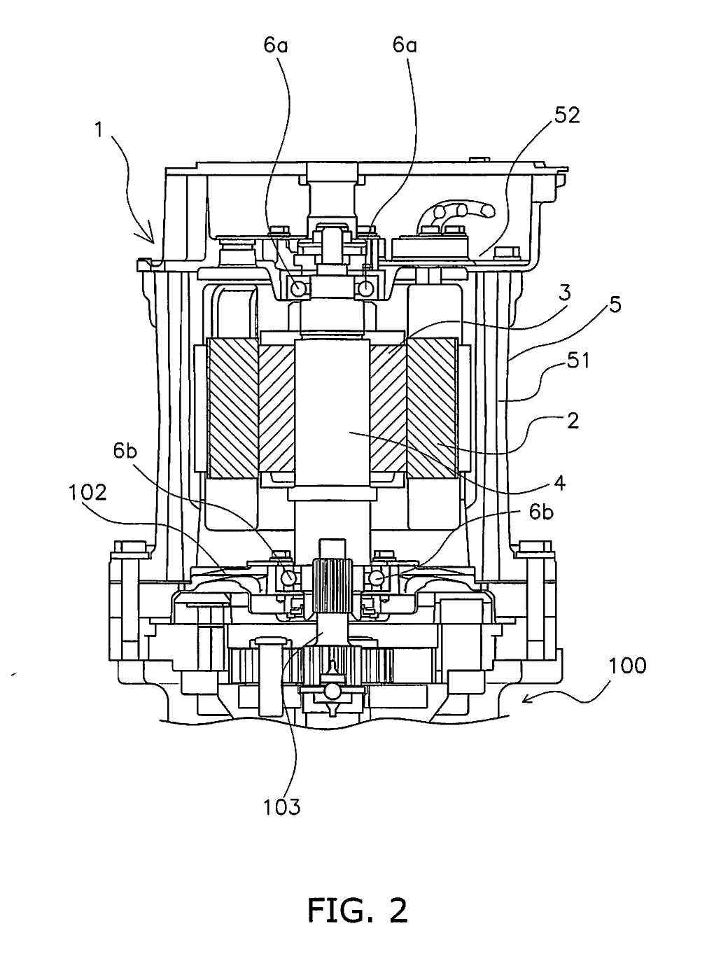

FIG. 1 is an oblique view of a dynamo-electric machine 1 in this embodiment, and FIG. 2 is a cross section of the internal structure of the dynamo-electric machine 1 in FIG. 1, cut along a plane passing through the center line A.

In FIGS. 1 and 2, swing machinery 100 is given as an example of what is driven by the drive force of the dynamo-electric machine 1 in this first exemplary embodiment.

The dynamo-electric machine I in this first exemplary embodiment is disposed on the upper side of the swing machinery 100, and the drive force generated by the dynamo-electric machine 1 is transmitted to the swing machinery 100. Here, the swing machinery 100 rotates an upper structure having a work implement and so forth with respect to a lower traveling unit having crawler belts, on a hydraulic excavator or another such work vehicle. The rotary drive force of the dynamo-electric machine 1 is transmitted through a reduction mechanism to an output gear, and the swing machinery 100 turns on the inside or outside of a swing circle that meshes with the output gear, thereby causing the upper structure to rotate with respect to the lower traveling unit.

Dynamo-Electric Machine 1

The dynamo-electric machine 1 in the first exemplary embodiment is a 3-phase alternating current dynamo-electric machine, and comprises a housing 5 that holds a stator 2, a rotor 3, and a shaft 4, as shown in FIG. 2.

The housing 5 is formed so as to cover the upper face 102 of the swing machinery 100, and has a cylindrical part 51 and a top part 52.

The stator 2 is disposed in the housing 5, and while it will be discussed in detail below, it is in the form of a circular ring having a space in the middle, and has a coil 20 (see FIG. 3; discussed below).

The rotor 3 is disposed rotatably in the center space of the stator 2. The rotor 3 is in the form of a circular column, and has a magnet provided around its outer peripheral side. The rotor 3 rotates such that its rotational axis is the up and down direction in the drawings.

The shaft 4 is disposed in the center of the rotor 3, and rotates along with the rotor 3. A bearing 6a that rotatably supports this shaft 4 is provided to the top part 52 of the housing 5, and a bearing 6b is provided to the upper face 102 of the swing machinery 100. The shaft 4 is linked at its lower end to a shaft 103 of the swing machinery 100.

Stator 2

FIG. 3 is an oblique view of the stator 2 in this exemplary embodiment. As shown in FIG. 3, the stator 2 in this exemplary embodiment comprises a cylindrical stator core 10 having a center axis A, and the coil 20 that is mounted to the stator core 10, and has an upper end face 10a and a lower end face 10b.

FIG. 4 is a plan view of the stator core 10. Slots 11 are formed in the stator core 10, going from the inner peripheral face 10c thereof toward the outer peripheral face 10d. 48 of these slots 11 are formed at regular intervals, and teeth 12 are formed in between the slots 11. Also shown are openings 11a of the slots 11 provided to the inner peripheral face 10c.

As shown in FIG. 4, the center axis of the stator core 10 is labeled A, the peripheral direction in plan view as seen from the axial direction is labeled C, and the radial direction is labeled R. This center axis A is the rotational center of the rotor 3, and “axial direction” refers to a direction that is parallel to this center axis A. The peripheral direction C is a direction running along the outer peripheral face 10d of the stator core 10. Here, of the peripheral direction C, we will let C1 be the counter-clockwise direction in plan view looking at the upper end face 10a from above in the axial direction, and let C2 be the clockwise direction. When we refer to the “peripheral direction C” herein, this indicates both C1 and C2. The radial direction R is a direction that links the outer peripheral face 10d of the stator core 10 from the center axis A in plan view looking in the axial direction. Of the radial direction R, we will let R1 be the inward direction and R2 the outward direction.

In this exemplary embodiment, the up and down direction is established in a state in which the center axis A is disposed perpendicular to the ground, the end face on the upper side of the stator core 10 is called the upper end face 10a, and the end face on the lower side is called the lower end face 10b, but the direction in which the stator core 10 is disposed is not limited to this orientation, and it may be disposed so that the center axis A is horizontal with respect to the ground. The term “horizontal” as used herein does not mean only horizontal in the strict sense. Since mechanical working, bending, and assembly of the constituent parts can produce variance, the word horizontal will be used for the purpose of description in this application even though it may not necessarily fit the precise geometric definition.

Coil 20

The coil 20 in this exemplary embodiment has a plurality of phase coils 21. Since the dynamo-electric machine 1 in this exemplary embodiment is a three-phase dynamo-electric machine, as the phase coils 21, a U-phase coil 21U, a V-phase coil 21V, and a W-phase coil 21W are provided, as shown in FIG. 3. The phase coils 21 each have a plurality of coil components 22 formed by joining a plurality of conductor segments 200 and 300.

Phase Coils 21

The phase coils 21 of the U-phase coil 21U, the V-phase coil 21V, and the W-phase coil 21W all have substantially the same configuration, so we will use the U-phase coil 21U as an example in the description that follows.

FIG. 5 is an oblique view of a U-phase coil component 22U. The U-phase coil 21U has a plurality of these U-phase coil components 22U.

The U-phase coil components 22U are formed by joining the conductor segments 200 and conductor segments 300 formed by rectangular wires 9. These rectangular wires 9 will be described first.

Rectangular Wires 9

The rectangular wires 9 are formed by copper or the like, for example, and their surface is covered by enamel or another such insulating film.

As shown in FIGS. 6A and 6B, the rectangular wires 9 have a rectangular cross sectional shape, and each have opposing first faces 9a and opposing second faces 9b. If we let W1 be the width of the first faces 9a, and W2 be the width of the second faces 9b, W1 is greater than W2. The ratio of W1 and W2 is from 1:2 to 1:3, for example. FIG. 6C is a diagram of the layout of the rectangular wires 9 in the slots 11. As will be described in detail below, in this exemplary embodiment three conductor segments 200 and three conductor segments 300 are altematingly disposed in each slot 11, in that order starting from the outer peripheral face 10d side. The conductor segments 200 and 300 are disposed so that the first faces 9a of the rectangular wires 9 are perpendicular to the peripheral direction C (that is, parallel to the radial direction R), and so that the second faces 9b of adjacent rectangular wires 9 are opposite each other.

Coil Components 22

As shown in FIG. 5, the U-phase coil components 22U are formed by having four conductor segments 200 and four conductor segments 300 alternatingly linked along the peripheral direction C. The lower ends of one conductor segment 200 and one conductor segment 300 form coil component ends 22a and 22b, which are the ends of the U-phase coil components 22U. A conductor segment 300, a conductor segment 200, a conductor segment 300, a conductor segment 200, a conductor segment 300, a conductor segment 200, and a conductor segment 300 are disposed in that order along the peripheral direction C1, going counter-clockwise in a plan view as seen from above from the conductor segment 200 having the coil component end 22a.

If we let the conductor segment 200 having the coil component end 22a (the end of the U-phase coil components 22U) be the first conductor segment 200 (indicated by hatching in FIG. 5) and number the others in order in the peripheral direction C1, the first conductor segment 200 and the second conductor segment 300 are joined at a joint 22c at their upper ends. The second conductor segment 300 and the third conductor segment 200 are joined at a joint 22d at their lower ends. The third conductor segment 200 and the fourth conductor segment 300 are joined at a joint 22c at their upper ends. The fourth conductor segment 300 and the fifth conductor segment 200 are joined at a joint 22d at their lower ends. The fifth conductor segment 200 and the sixth conductor segment 300 are joined at a joint 22c at their upper ends. The sixth conductor segment 300 and the seventh conductor segment 200 are joined at a joint 22d at their lower ends. The seventh conductor segment 200 and the eighth conductor segment 300 are joined at a joint 22c at their upper ends. The lower end of the eighth conductor segment 300 forms a coil component end 22b that is the end of the coil component 22.

As discussed above, the conductor segments 200 are joined at the joints 22c at the upper ends to the conductor segments 300 disposed adjacent to the peripheral direction C 1 side, and are joined at the joints 22d at the lower ends to the conductor segments 300 disposed adjacent to the peripheral direction C2 side.

The conductor segments 200 and 300 forming the phase coils 21 will now be described.

Conductor Segments 200

FIG. 7 is an oblique view of a conductor segment 200. As illustrated in FIG. 6A, the conductor segment 200 is disposed in a slot 11 such that its first face 9a is perpendicular to the peripheral direction C.

This conductor segment 200 is formed by bending a rectangular wire 9 while maintaining a state in which the first face 9a is perpendicular to the peripheral direction C (a state in which the first face 9a is parallel to the radial direction R). The conductor segment 200 is formed maintaining a state in which the first face 9a is parallel to the radial direction R.

As shown in FIG. 3, the conductor segment 200 protrudes from the upper end face 10a and the lower end face 10b of the stator core 10 in a state of being disposed in the slot 11. The conductor segment 200 has a straight section 201 that is disposed in the slot 11, a first protruding section 202 that protrudes from the upper end face 10a, and a second protruding section 203 that protrudes from the lower end face 10b. The first protruding section 202 is bent in the peripheral direction C1, using the straight section 201 as a reference. The second protruding section 203 is bent in the peripheral direction C2.

The first protruding section 202 of the conductor segment 200 has a sloped section 202a formed in the peripheral direction C1 from the upper end of the straight section 201 (the portion coming out of the slot 11), and a vertical section 202b formed vertically with respect to the upper end face 10a from the distal end of the sloped section 202a.

The bent portions between the straight section 201 and the sloped section 202a, and between the sloped section 202a and the vertical section 202b are such that the first face 9a side of the rectangular wire 9 is bent, and the second face 9b is maintained in the same plane. The term “vertical” as used herein does not mean only vertical in the strict sense. Variance can be caused by mechanical working, bending, and assembly of the constituent parts, so the word vertical will be used for the purpose of description in this application even though it may not necessarily fit the precise geometric definition.

The second protruding section 203 of the conductor segment 200 has a sloped section 203a formed by bending from the lower end of the straight section 201 (the portion coming out of the slot 11) in the peripheral direction C2 to the lower end face 10b side, and a vertical section 203b formed vertically with respect to the lower end face 10b from the lower end of the sloped section 203a.

The bent portions between the straight section 201 and the sloped section 203a, and between the sloped section 203a and the vertical section 203b are such that the first face 9a side of the rectangular wire 9 is bent, and the second face 9b is maintained in the same plane.

Conductor Segment 300

FIG. 8 is an oblique view of a conductor segment 300. As illustrated in FIG. 6A, the conductor segment 300 is disposed in the slot 11 such that its first face 9a is perpendicular to the peripheral direction C.

This conductor segment 300 is formed by bending the rectangular wire 9 while maintaining the first face 9a in a state of being perpendicular to the peripheral direction C (a state in which the first face 9a is parallel with the radial direction R). The conductor segment 300 is formed in a state of maintaining the state in which the first face 9a is parallel with the radial direction R.

As shown in FIG. 3, the conductor segment 300 protrudes from the upper end face 10a and the lower end face 10b of the stator core 10 in a state of being disposed in a slot 11. As shown in FIG. 8, the conductor segment 300 has a straight section 301 that is disposed in the slot 11, a first protruding section 302 that protrudes from the upper end face 10a, and a second protruding section 303 that protrudes from the lower end face 10b. The first protruding section 302 is bent in the peripheral direction C2, using the straight section 301 as a reference. The second protruding section 303 is bent in the peripheral direction C1.

The first protruding section 302 of the conductor segment 300 has a sloped section 302a formed in the peripheral direction C2 from the upper end of the straight section 301 (the portion coming out of the slot 11), a vertical section 302b formed vertically with respect to the upper end face 10a from the distal end of the sloped section 302a, and a horizontal section 302c formed parallel with the upper end face 10a and extending in the outer peripheral direction (the outward radial direction R2) of the stator core 10 from the distal end of the vertical section 302b.

The bent portion between the straight section 301 and the sloped section 302a, and the bent portion between the sloped section 302a and the vertical section 302b are such that the first face 9a side of the rectangular wire 9 is bent, and the second face 9b is maintained in the same plane. The bent portion between the vertical section 302b and the horizontal section 302c is such that the second face 9b side of the rectangular wire is bent as shown in the detail view T in FIG. 8, and the first face 9a is maintained in the same plane. When the conductor segments 300 are mounted to the stator core 10, the rectangular wires 9 are bent approximately 90 degrees from the vertical section 302b to the horizontal section 302c. The direction in which the rectangular wires 9 are bent is the outward radial direction R2 when the conductor segments 300 have been mounted to the stator core 10.

The second protruding section 303 of the conductor segment 300 has a sloped section 303a formed in the peripheral direction C1 from the lower end of the straight section 301 (the portion coming out of the slot 11), a vertical section 303b formed vertically with respect to the lower end face 10b from the distal end of the sloped section 303a, and a horizontal section 303c formed extending in the outer peripheral direction of the stator core 10 from the distal end of the vertical section 303b.

The bent portion between the straight section 301 and the sloped section 303a, and the bent portion between the sloped section 303a and the vertical section 303b are such that the first face 9a side of the rectangular wire 9 is bent, and the second face 9b is maintained in the same plane. The bent portion between the vertical section 303b and the horizontal section 303c is such that the second face 9b side of the rectangular wire is bent, and the first face 9a is maintained in the same plane. The rectangular wires 9 are bent approximately 90 degrees from the vertical section 303b to the horizontal section 303c. The direction in which the rectangular wires 9 are bent is the outward radial direction R2 when the conductor segments 300 have been mounted to the stator core 10.

As shown in the detail view S in FIG. 5, the vertical section 202b of the conductor segment 200 and the horizontal section 302c of the conductor segment 300 are joined by TIG welding or the like at the joint 22c, and the vertical section 203b of the conductor segment 200 and the horizontal section 303c of the conductor segment 300 are joined at the joint 22d, and this is how the phase coils 21 of each phase are formed.

No horizontal section 303c is formed on the second protruding section 303 of the eighth conductor segment 300 shown in FIG. 5, and only the vertical section 303b is formed, so that this vertical section 303b constitutes the coil component end 22b.

Coil Component Set 23

A coil component set 23 is formed for each phase by disposing three coil components 22 with the above configuration in the radial direction R.

FIG. 9 is an oblique view of a U-phase coil component set 23U. FIG. 10 is an oblique view of a state in which just the U-phase coil component set 23 has been disposed in the stator core 10.

As shown in FIG. 10, the conductor segments 200 and 300 of a single U-phase coil component 22U are disposed with five slots 11 provided in between adjacent conductor segments 200 and 300 in the peripheral direction C.

The various conductor segments 200 and 300 of the three U-phase coil components 22U in the U-phase coil component set 23U are disposed in the same slots 11. More precisely, the first conductor segments 200 having the coil component ends 22a of the various three U-phase coil components 22U are disposed in the same slot 11, and the second conductor segments 300 are disposed in a single slot 11. Similarly, the third to eighth conductor segments 200 and 300 are disposed in a single slot 11. The joints 22c of the three U-phase coil components 22U in the U-phase coil component set 23 are aligned in the radial direction Ron the upper end face 10a side, and the joints 22d are on the lower end face 10b side.

In this exemplary embodiment, four of these U-phase coil component sets 23U are disposed to form the U-phase coil 21U.

Assembly of phase Coil Component Sets 23

FIG. 11 is a schematic view of a state in which one U-phase coil component set 23U is mounted in the stator core 10, as seen from the inner peripheral face 10c side. Actually, three rectangular wires are disposed in the depth direction of the drawings, but just one rectangular wire 9 is shown to make it easier to understand.

In FIG. 11, the inner peripheral face 10c is hatched to make the slots 11 easier to see.

The U-phase coil 21U is constructed by combining four U-phase coil component sets 23U. In order to distinguish among the various U-phase coil component sets 23U, they will be referred to as the first U-phase coil component set 23(1)U, the second U-phase coil component set 23(2)U, the third U-phase coil component set 23(3)U, and the fourth U-phase coil component set 23(4)U. As for the conductor segments 200 and 300, when we refer to the conductor segments 200 and 300 of the first U-phase coil component set 23U, they will be numbered 200(1) and 300(1), and similarly with the other U-phase coil component sets 23(2), 23(3), and 23(4), these will be numbered 200(2), 300(2), 200(3), 300(3), 200(4), and 300(4).

FIG. 11 is a schematic view of a state in which just the first U-phase coil component set 23(1)U has been mounted to the stator core 10.

FIG. 12 is a diagram of a state in which the first U-phase coil component set 23(1)U and the second U-phase coil component set 23(2)U have been mounted to the stator core 10. The second U-phase coil component set 23(2)U is indicated with a broken line to distinguish it from the first U-phase coil component set 23(1)U.

As shown in FIG. 12, the second U-phase coil component set 23(2)U is mounted to the stator core 10 by moving over six slots 11 in the peripheral direction C from the first U-phase coil component set 23(1)U.

The conductor segments 200 of the first U-phase coil component set 23(1)U and the conductor segments 300 of the second U-phase coil component set 23(2)U are mounted in the same slot 11. The conductor segments 300 of the first U-phase coil component set 23(1)U and the conductor segments 200 of the second U-phase coil component set 23(2)U are disposed in the same slot 11.

The joints 22d(2) of the second U-phase coil component sets 23(2)U are disposed on the lower side, flanking the stator core 10, of the joints 22c(l) of the first U-phase coil component set 23(1)U. The joints 22d(1) of the first U-phase coil component set 23(1)U are disposed on the lower side, flanking the stator core 10, of the joints 22c(2) of the second U-phase coil component set 23(2)U.

In FIG. 12, only one each of the conductor segments 200 and 300 of the first U-phase coil component set 23(1)U and the second U-phase coil component set 23(2)U are shown disposed in one slot 11, but actually three of each are disposed in one slot 11.

Next, we will discuss the disposition of the conductor segments 200 and 300 of the first U-phase coil component set 23(1)U and the second U-phase coil component set 23(2)U in the slots 11.

FIG. 13 illustrates the layout of the conductor segments 200 and 300 of the first U-phase coil component set 23(1)U and the second U-phase coil component set 23(2)U in the slots 11. As shown in FIG. 13, the conductor segments 200(1) of the first U-phase coil component set 23(1)U and the conductor segments 300(2) of the second U-phase coil component set 23(2)U are alternately disposed in a slot 11. More precisely, a conductor segment 300(2), a conductor segment 200(1), a conductor segment 300(2), a conductor segment 200(1), a conductor segment 300(2), and a conductor segment 200(1) are disposed in that order in one slot 11 in the direction of the outer peripheral face 10d from the inner peripheral face 10c. A conductor segment 300(1), a conductor segment 200(2), a conductor segment 300(1), a conductor segment 200(2), a conductor segment 300(1), and a conductor segment 200(2) are disposed in that order in another slot 11.

Thus, a total of six of the conductor segments 200 and 300 are disposed in the order of the conductor segments 300 and the conductor segments 200 from the inner peripheral face 10c toward the outer peripheral face 10d.

Joining of Conductor Segments 200 and 300

The joined portions of the conductor segments 200 and the conductor segments 300 will now be described in detail. As shown in the detail view S in FIG. 5 and the detail view X in FIG. 13, the first faces 9a of the horizontal sections 302c of the conductor segments 300 (indicated by P1 in parentheses in the drawings) and the first faces 9a of the vertical sections 202b of the conductor segments 200 (indicated by P2 in parentheses in the drawings) are butted together and joined. The rectangular wire 9 has two first faces 9a, and to put this more precisely, the first face 9a of the vertical section 202b on the slot 11 side where the conductor segment 300 to be joined is disposed, is opposite the first face 9a of the horizontal section 302c on the slot 11 side where the conductor segment 200 to be joined is disposed.

As shown in FIG. 13, in the first U-phase coil component set 23U, one of the conductor segments 300(1) is disposed more to the inside in the radial direction R at a position in a slot 11 than the conductor segment 200(1) to which it is joined. Since the horizontal section 302c of the conductor segment 300(1) extends outward, the first face 9a of the horizontal section 302c of the conductor segment 300(1) and the first face 9a of the vertical section 202b of the conductor segment 200(1) can be opposite each other and butted together as shown in the detail view X in FIG. 13.

As shown in FIG. 13, the second conductor segment 200(1) from the inner peripheral to face 10c of the stator core 10 toward the outer peripheral face 10d and the first conductor segment 300(1) from the inside are joined on their upper end side. The fourth conductor segment 200(1) from the inside and the third conductor segment 300(I) from the inside are joined at their upper end side. The sixth conductor segment 200(1) from the inside and the fifth conductor segment 300(1) from the inside are joined at their upper end side. In FIG. 13, T indicates the outermost conductor segment 200(1) of the U-phase coil component 22U, and Q the outermost conductor segment 300(2).

Thus, the conductor segments 200 and the conductor segments 300 are put together, and the conductor segment 200 disposed in the (i+1)-th (where i is greater than or equal to 1) position from the inside and the conductor segment 300 disposed in the i-th position from the inside are joined. Since the conductor segments 200 and the conductor segments 300 are disposed in order from the inside of the stator core 10 in the outward radial direction R2, more precisely, i is an odd number.

The first faces 9a of the horizontal section 303c and the vertical section 303b are joined opposite each other on the lower end face 10b side in between the conductor segment 300(2) and the conductor segment 200(2) of the second U-phase coil component set 23(2)U.

The first U-phase coil component set 23(1)U and the second U-phase coil component set 23(2)U are combined as discussed above, but with the U-phase coil 21U in this exemplary embodiment, two sets of this combination are provided.

FIG. 14 is a schematic view of the state when four U-phase coil component sets 23U have been mounted in the stator core. As shown in FIG. 14, the third U-phase coil component set 23(3)U is disposed in the stator core 10 by being shifted over by one slot 11 in the peripheral direction C1 from the first U-phase coil component set 23(1)U. The fourth U-phase coil component set 23(4)U is disposed in the stator core 10 by being shifted over by one slot 11 in the peripheral direction C1 from the second U-phase coil component set 23(2)U.

The conductor segments 200(3) of the third U-phase coil component set 23(3)U and the conductor segments 300(4) of the fourth U-phase coil component set 23(4)U are disposed alternately in the same slot 11. Also, the conductor segments 300(3) of the third U-phase coil component set 23(3)U and the conductor segments 200(4) of the fourth U-phase coil component set 23(4)U are disposed alternately in the same slots 11. As discussed above, the conductor segments 300(3) and the conductor segments 200(4) are disposed alternately in that order, and the conductor segments 300(4) and the conductor segments 200(3) are disposed alternately in that order, from the inner peripheral face 10c toward the outer peripheral face 10d.

The U-phase coil 21U is formed by combining four U-phase coil component sets 23U as discussed above.

The stator 2 in this exemplary embodiment has the U-phase coil 21U with this configuration, and a V-phase coil 21V and a W-phase coil 21W with the same configuration as the U-phase coil 21U, mounted in the stator core 10.

Disposition of Phase Coils 21

FIG. 15 is a partial plan view illustrating the mounting state of the phase coils 21 in the stator core 10. In FIG. 15, the conductor segments 200 and 300 of the first U-phase coil component set 23(1)U are numbered 200(1)U and 300(1)U as an example. Similarly, for the second, third, and fourth U-phase coil component sets 23(2)U, 23(3)U, and 23(4)U, the numbering is 200(2)U, 300(2)U, 200(3)U, 300(3)U, 200(4)U, and 300(4)U.

The same applies to the conductor segments 200 and 300 of the first to fourth V-phase coil component sets 21(1)V to 21(4)V of the V-phase coil 21 V, and to the first to fourth W-phase coil component sets 21(1)W to 21(4)W of the W-phase coil 21W. The dots in circles in the conductor segments 200 and 300 indicate that current is flowing toward the viewer of the drawing, and the x marks in circles indicate that current is flowing away from the viewer of the drawing.

The conductor segments 200(1)U of the first U-phase coil component set 23(1)U and the conductor segments 300(2)U of the second U-phase coil component set 23(2)U are disposed alternately in the first slot 11A (going in the peripheral direction C1 from the slot 11A shown in FIG. 15).

Using the slot 11A as the first slot, the conductor segments 200(3)U of the third U-phase coil component set 23(3)U, and the conductor segments 300(4)U of the fourth U-phase coil component set 23(4)U are disposed alternately in the second slot 11 in the peripheral direction C1.

The conductor segments 200(1)V of the first V-phase coil component set 23(1)V, and the conductor segments 300(2)V of the second V-phase coil component set 23(2)V are disposed to alternately in the third slot 11. The conductor segments 200(3)V of the third V-phase coil component set 23(3)V, and the conductor segments 300(4)V of the fourth V-phase coil component set 23(4)V are disposed alternately in the fourth slot 11.

The conductor segments 200(1)W of the first W-phase coil component set 23(1)W, and the conductor segments 300(2)W of the second W-phase coil component set 23(2)W are disposed alternately in the fifth slot 11. The conductor segments 200(3)W of the third W-phase coil component set 23(3)W, and the conductor segments 300(4)W of the fourth W-phase coil component set 23(4)W are disposed alternately in the sixth slot 11.

The conductor segments 200(2)U of the second U-phase coil component set 23(2)U, and the conductor segments 300(1)U of the first U-phase coil component set 23(1)U are disposed alternately in the seventh slot 11. The conductor segments 200(4)U of the fourth U-phase coil component set 23(4)U, and the conductor segments 300(3)U of the third U-phase coil component set 23(3)U are disposed alternately in the eighth slot 11.

The conductor segments 200(2)V of the second V-phase coil component set 23(2)V, and the conductor segments 300(1)V of the first V-phase coil component set 23(1)V are disposed alternately in the ninth slot 11. The conductor segments 200(4)V of the fourth V-phase coil component set 23(4)V, and the conductor segments 300(3)V of the third V-phase coil component set 23(3)V are disposed alternately in the tenth slot 11.

The conductor segments 200(2)W of the second W-phase coil component set 23(2)W, and the conductor segments 300(1)W of the first W-phase coil component set 23(1)W are disposed alternately in the eleventh slot 11. The conductor segments 200(4)W of the fourth W-phase coil component set 23(4)W, and the conductor segments 300(3)W of the third W-phase coil component set 23(3)W are disposed alternately in the twelfth slot 11.

The conductor segments 200 and 300 of the various phase coils 21 are then disposed in the thirteenth to twenty-fourth slots 11 in the same manner as in the first to the twelfth slots 11. The conductor segments 200(1)U of the first U-phase coil component set 23(1)U and the conductor segments 300(2)U of the second U-phase coil component set 23(2)U are disposed alternately in the thirteenth slot 11 in the same manner as in the first slot 11A.

With the stator 2 in this embodiment, the disposition in the above-mentioned first to twelfth slots 11 is repeated four times in the peripheral direction C1, so that the U-phase coils 21U, V-phase coils 21V, and W-phase coils 21W are mounted in 48 of the slots 11, thereby configuring the stator 2 of this exemplary embodiment.

As shown in FIG. 15, in the first and second slots 11 the current flows toward the viewer of the drawing, and in the third and fourth slots 11 the current flows away from the viewer of the drawing. Thus, the orientation of current is switched every two slots 11 in the peripheral direction C1. The coil component ends 22a and 22b shown in FIG. 5 are suitably connected by connecting wires 90 or the like as shown in FIG. 3 so as to achieve this current orientation.

2. Manufacturing Method

Next, the method for manufacturing the stator 2 in this first exemplary embodiment will be described.

The manufacture of the stator in this exemplary embodiment comprises a conductor segment production step of forming conductor segments 200 and 300, a disposition step of disposing the conductor segments 200 and 300 in the stator core 10, and a welding step of welding the conductor segments 200 and 300 together.

Step of Forming Conductor Segments 200 and 300

FIG. 16 is a flowchart of the method for producing the conductor segments 200 and 300 in this exemplary embodiment. FIGS. 17A to 17C are diagrams illustrating the steps for producing the conductor segments 300.

First of all, the rectangular wires 9 are cut at both ends to a specific size in order to form the conductor segments 200 and 300 (S1).

Next, the cover film is peeled off from both ends of the conductor segments 200 and 300 (S2). This peeling of the film is accomplished by scraping away the film by punching with a die.

Then, the two distal ends of the conductor segment 300 disposed at the i-th position counting from the inside of the stator core 10, that is, at an odd-numbered position counting from the inside of the stator core 10, are bent 90 degrees in the same direction (S3). In S3, the rectangular wires 9 are bent in a state in which the first faces 9a are maintained in the same plane, thereby forming the horizontal sections 302c and 303c as shown in FIG. 17A (see the portion J in the broken line circle).

Next, the conductor segments 200 and the conductor segments 300 are formed in an S shape (S4). In S4, as shown in FIG. 17B, the first faces 9a of the rectangular wires 9 are bent so that the second faces 9b are maintained in the same plane (see the portion K in the broken line circle).

Then, the conductor segments 200 and 300 are formed so as to curve along the peripheral direction C of the stator core 10 (S5). In S5, as shown in FIG. 17C, the sloped section 302a and the sloped section 303a of the conductor segment 300 are formed so as to curve along the peripheral direction C of the stator core 10 (see the portion L in the broken line circle).

The conductor segments 200 are produced in the same manner as the conductor segments 300, except that step S3 is not performed.

This produces the conductor segments 200 and 300.

Disposition Step

Next, the conductor segments 200 and 300 are disposed in the slots 11 of the stator core 10. In disposing the conductor segments 200 and 300 in the slots 11, the conductor segments 200 and 300 are disposed in the slots 11 through the openings 11a (see FIG. 4) of the slots 11 from the inner peripheral face 10c of the stator core 10.

More precisely, after the conductor segments 200 and 300 are disposed to the inside of the inner peripheral face 10c of the stator core 10, they move in the outward radial direction R2, and the straight sections 201 and 301 thereof are inserted through the openings 11a into the slots 11, thereby disposing the conductor segments 200 and 300 in the slots 11.

Welding Step

FIG. 18 shows the state when joints are welded. As shown in FIG. 18, a plurality of welding sites 800 are provided at which the vertical sections 202b and the horizontal sections 302c to be welded are opposite each other. In between these welding sites 800, wedge-shaped welding electrodes 701 are inserted between the vertical sections 202b and the horizontal sections 302c to be welded, from the outer peripheral face 10d side of the stator core 10. The welding electrodes 701 are connected to power cords 702, and a welding torch 703 is disposed above the welding sites 800. When a plurality of welding sites 800 are disposed between the two welding electrodes 701, an electroconductive wedge 704 is inserted in between the welding sites 800. In FIG. 18, two of the wedges 704 are inserted. This insertion of the welding electrodes 701 and the wedges 704 allows the opposing first faces 9a of the vertical sections 202b and the horizontal sections 302c to be brought into contact.

With this configuration, the opposing portions of the vertical sections 202b and the horizontal sections 302c are TIG welded from above.

When a plurality of welding sites 800 are welded, because the wedges 704 are disposed between the welding electrodes 701, there is no need to move the position of the welding electrodes 701 each time, so welding can be carried out continuously. Inserting the wedges 704 flanking the welding sites 800 and the welding electrodes 701 ensures that the welding sites will be stable.

As shown in FIG. 19, joints 22c are formed at the opposing portions of the vertical sections 202b and the horizontal sections 302c. In FIG. 19, portions that are not yet joined (the welding sites 800) are also shown.

Similarly, joints 22d are formed at the opposing portions of the vertical sections 203b and the horizontal sections 303c on the lower end face 10b side.

Finally, connecting wires 90 (see FIG. 3) are provided as needed to manufacture the stator 2 of this embodiment.

3. Features

(3-1)

The stator 2 in the above exemplary embodiment comprises the stator core 10 and the coil 20. The stator core 10 is cylindrical, and has a plurality of slots 11 formed in the radial direction to the inside thereof. The coil 20 has a plurality of conductor segments 200 and 300 disposed in the slots 11, and are formed by joining the vertical sections 202b and 203b (an example of ends) of the conductor segments 200 to the horizontal sections 302c and 303c (an example of ends) of the conductor segments 300. The conductor segments 200 and 300 have a rectangular cross section, and are formed by the rectangular wire 9 having wider first faces 9a and narrower second faces 9b. The first faces 9a are disposed in the slots 11 so that the first faces 9a are parallel to the radial direction R. A plurality of the conductor segments 200 and 300 are disposed in each of the slots 11 so that the second faces 9b are opposite each other. The conductor segment 300 disposed in the i-th (where i is an integer greater than or equal to 1) position from the inside of the stator core 10 is joined to the conductor segment 200 disposed in the (i+1)-th (where i is an integer greater than or equal to 1) position from the inside of the stator core 10, with the vertical sections 202b and 203b and the horizontal sections 302c and 303c opposite each other, respectively. The joined opposing first faces 9a are formed parallel to the radial direction R.

Since the conductor segments 200 and 300 are thus joined at the wider first faces 9a, sufficient joint strength can be ensured even though welding is performed without compressing the ends of the conductor segments 200 and 300.

Since the ends of the conductor segments 200 and 300 do not need to be compressed, even if the portions to be welded are close together, a stator 2 can still be provided with which sufficient joint strength can be ensured.

The same cross sectional area as the conductor segments 200 and 300 needs to be ensured at the joined portions, but since the wider first faces 9a are put opposite each other and joined, the joint depth should be equivalent to the width of the second faces 9b, which keeps the end height of the coil 20 low. This allows ensures good conductivity.

(3-2)

As shown in FIG. 13, the stator 2 in the above exemplary embodiment is such that the to horizontal sections 302c and 303c (an example of ends) of the i-th conductor segment 300 are bent outward toward the vertical sections 202b and 203b (an example of ends) of the (i+1)-th conductor segment 200 so that the second faces 9b curve, and are joined to the vertical sections 202b and 203b of the (i+1)-th conductor segment 200.

In manufacturing the stator 2, the vertical sections 202b and 203b and the horizontal sections 302c and 303c of the conductor segments 200 and 300 to be joined are located to the outside of the stator core 10.

In welding the ends of the conductor segments 200 and 300 together, in order to maintain a state in which the vertical sections 202b and 203b of the conductor segments 200 and the horizontal sections 302c and 303c of the conductor segments 300 to be joined are in contact, the wedge-shaped welding electrodes 701 and the wedges 704 are inserted from the outer peripheral side of the stator core 10 into the outside in the peripheral direction C of the ends of the vertical sections 202b and 203b and the horizontal sections 302c and 303c that are disposed opposite each other.

Here, the spacing between positions to be joined that are adjacent in the peripheral direction C (the welding sites 800) will be wider when the positions of the vertical sections 202b and 203b and the horizontal sections 302c and 303c to be joined are located to the outside of the stator core 10.

(3-3)

The stator 2 in the above exemplary embodiment is such that the opposing first faces 9a are the first face 9a of the i-th conductor segment 300 on the slot 11 side on which the (i+1)-th conductor segment 200 is disposed (indicated by P1 in parentheses in FIG. 13), and the first face 9a of the (i+1)-th conductor segment 200 on the slot side on which the i-th conductor segment 300 is disposed (indicated by P2 in parentheses in FIG. 13).

Consequently, the conductor segments 200 and 300 can be joined together at a shorter distance.

(3-4)

With the stator 2 in the above exemplary embodiment, the conductor segments 200 and 300 have the straight sections 201 and 301 (an example of in-slot portions) disposed in the slots 11, the first protruding sections 202 and 302 that protrude from the upper end face 10a (an example of a first end face) out of the two end faces of the stator core 10, and the second protruding sections 203 and 303 that protrude from the lower end face 10b (an example of a second end face) out of these two end faces. The vertical sections 202b and 203b and the horizontal sections 302c and 303c (an example of ends) are provided to both the first protruding sections 202 and 302 and the second protruding sections 203 and 303, and the joined opposing first faces 9a are provided on both the first protruding sections 202 and 302 side and the second protruding sections 203 and 303 side.

Thus, the conductor segments 200 and 300 are such that the vertical sections 202b and 203b and the horizontal sections 302c and 303c are formed on the respective portions protruding from both end faces of the stator core 10, and are joined with other conductor segments 200 and 300 at these vertical sections 202b and 203b and horizontal sections 302c and 303c. The conductor segments 200 and 300 are not formed so as to span two or more slots 11, and are disposed in only one slot 11.

Consequently, even after bending has been performed, the conductor segments 200 and 300 can still be inserted into the slots 11 from the inside of the stator core 10. Since the conductor segments 200 and 300 are in a bent state, it is difficult to dispose them as shown in FIG. 3 by inserting from the upper end face 10a or the lower end face 10b of the stator core 10. However, as shown in FIGS. 5 and 17, since the conductor segments 200 and 300 have end parts at top and bottom, even in this bent state, the conductor segments 200 and 300 can be easily disposed in the state in FIG. 3 by being inserted into the slots 11 through the openings 11a.

Since the conductor segments 200 and 300 do not need to be bent after they have been inserted into the slots 11, working can be carried out with ease.

(3-5)

With the stator 2 in the above exemplary embodiment, four or more of the conductor segments 200 and 300 are disposed in each of the slots 11 so that the second faces 9b are opposite each other, and a plurality of the joined opposing first faces 9a are disposed along the radial direction R.

Thus, even when a plurality of ends that are to be joined are provided along the radial direction R, since there is no need for compression, no fixing (clamping) needs to be performed, and welding can be carried out that ensures sufficient joint strength.

(3-6)

The dynamo-electric machine 1 in the above exemplary embodiment comprises the stator 2 and the rotor 3 that is disposed on the inside of the stator 2.

Consequently, a dynamo-electric machine 1 can be obtained that is equipped with a stator 2 that ensures sufficient joint strength.

### Second Exemplary Embodiment

A second exemplary embodiment pertaining to the present invention will now be described.

1. Configuration

In the first exemplary embodiment above, the joined conductor segments 200 and conductor segments 300 are adjacent when viewed along the peripheral direction C, with no gap in between them, but with the coil 20 in the second exemplary embodiment, a gap is formed between the conductor segments 200 and the conductor segments 300. The description of the second exemplary embodiment below will focus on the differences from the first exemplary embodiment.

FIG. 20A is an oblique view of the area near the joined portion of a conductor segment 200 and a conductor segment 300. FIG. 20B is a diagram of the state in FIG. 20A when viewed along the peripheral direction C. FIG. 20C is a diagram of the conductor segment 200 and the conductor segment 300 in the above exemplary embodiment when viewed along the peripheral direction C. Although not shown in the first exemplary embodiment, in the second exemplary embodiment a state is shown in which the cover films have been peeled away from the ends of the conductor segment 200 and the conductor segment 300, and as shown in FIG. 20C, the portion where the cover film has been peeled away from the conductor segment 300 is indicated by 300E, and the portion where the cover film has been peeled away from the conductor segment 200 is indicated by 200E.

As shown in FIG. 20C, in the first exemplary embodiment, when viewed along the peripheral direction C, the first protruding section 302 of the conductor segment 300 and the first protruding section 202 of the conductor segment 200 are disposed adjacent to each other, so that no gap is formed (see the D area).

On the other hand, as shown in FIGS. 20A and 20B, a gap B is formed between the first protruding section 202 of the conductor segment 200 and the first protruding section 302 of the conductor segment 300 in the second exemplary embodiment. Forming this gap B makes it easier for an insulating sheet 60 to be fitted in between as shown in FIG. 20D. The width of the gap B can be suitably varied to make it easier to dispose an insulating sheet of the proper thickness (such as 1 mm) and ensure electrical insulation.

FIG. 21 is a plan view of the connection relation between the conductor segment 200 and the conductor segment 300 in the formation of the gap B. In FIG. 21, the conductor segments 200 and 300 of the first coil component set 23(1) and the second coil component set 23(2) of either U-phase, V-phase, or W-phase are shown. The conductor segments 200 and 300 of the first coil component set 23(1) are shown as the conductor segments 200(1) and 300(1), and the conductor segments 200 and 300 of the second coil component set 23(2) are shown as the conductor segments 200(2) and 300(2).

As shown in FIG. 13, in the first exemplary embodiment, six of the conductor segments 200 and 300 are disposed in a single slot 11, but in FIG. 21, four of the conductor segments 200 and 300 are disposed in a single slot 11. With the coil component sets 23 in the first exemplary embodiment, three coil components 22 are disposed in the radial direction as shown in FIG. 9, but with the coil component sets 23 in the second exemplary embodiment, two coil components 22 are disposed in the radial direction.

As shown in FIG. 21, a conductor segment 300, a conductor segment 200, a conductor segment 300, and a conductor segment 200 are disposed in that order from the inner peripheral side toward the outer peripheral side in a single slot 11.

Compared to FIG. 13 in the first exemplary embodiment, as shown in FIG. 21 and the detail view X therein, the vertical section 202b of the conductor segment 200(1) disposed on the outermost peripheral side is disposed toward the outer peripheral face 10d, to the extent that it does not protrude to the outside from the outer peripheral face 10d in plan view. The horizontal section 302c of the conductor segment 300(1) disposed on the inside is formed so as to reach the vertical section 202b disposed toward the outer peripheral face 10d. Consequently, the gap B is formed between the conductor segment 200(1) disposed on the outermost peripheral side and the conductor segment 300(1) that is joined to this conductor segment 200(1), as viewed in the peripheral direction C. In the detail view X in FIG. 21, the vertical section 2026 and the vertical section 302b are dotted.

As shown in the detail view Y in FIG. 21, the vertical section 302b of the conductor segment 300(1) disposed on the innermost peripheral side is disposed toward the inner peripheral face 10c, to the extent that it does not protrude to the inside from the inner peripheral face 10c in plan view. The horizontal section 302c is formed so as to reach the vertical section 202b of the conductor segment 200(1) disposed on the outside from the vertical section 302b disposed toward the inner peripheral face 10c. Therefore, as shown in the detail view Y in FIG. 21, the gap B can be formed between the conductor segment 300(1) disposed on the innermost peripheral side and the conductor segment 200(1) that is joined to this conductor segment 300, as viewed in the peripheral direction C. In the detail view Y in FIG. 21, the vertical section 202b and the vertical section 302b are dotted.

As discussed above, the gap B is formed between the conductor segment 200 and the conductor segment 300, and the insulating sheet 60 is disposed in this gap B, which provides electrical insulation between conductor segments that are adjacent in the radial direction R.

In the above description, the upper side of the stator 2 is described, but the lower side has the same configuration, and a gap is formed between the second protruding section 303 of the conductor segment 300 and the second protruding section 203 of the conductor segment 200 when viewed along the peripheral direction C.

2. Main Features

The second exemplary embodiment also has the following features.

With the stator 2 in the second exemplary embodiment, the gap B is formed between the first protruding section 302 of the first (an example of the i-th) conductor segment 300 and the first protruding section 202 of the second (an example of the (i+1)-th) conductor segment 200 counting from the inner peripheral side, as viewed in the peripheral direction C of the stator core 10. A gap is also formed between the second protruding section 303 of the first (an example of the i-th) conductor segment 300 and the second protruding section 203 of the second (an example of the (i+1)-th) conductor segment 200, as viewed in the peripheral direction C. The gap B is formed between the first protruding section 302 of the third (an example of the i-th) conductor segment 300 and the first protruding section 202 of the fourth (an example of the (i+1)-th) conductor segment 200 counting from the inner peripheral side, as viewed in the peripheral direction C of the stator core 10. A gap is also formed between the second protruding section 303 of the third (an example of the i-th) conductor segment 300 and the second protruding section 203 of the fourth (an example of the (i+1)-th) conductor segment 200, as viewed in the peripheral direction C.

As discussed above, since the gap B is formed between the conductor segments 200 and the conductor segments 300, it is easier to fit the insulating sheet 60 in between as shown in FIG. 20d. Since the thickness of the insulating sheet 60 can be increased, insulation can be ensured more reliably.

### Third Exemplary Embodiment

The third exemplary embodiment pertaining to the present invention will now be described.

1. Configuration

With the coil in the first exemplary embodiment above, with all of the conductor segments, those on the inside in the radial direction R (the inward radial direction R1) extend toward the outside conductor segments, but with the coil in the third exemplary embodiment, the conductor segments on the outside in the radial direction R (the outward radial direction R2) also are configured to extend toward the inside conductor segments.

FIG. 22 is a partial oblique view of a coil component set 23′, of either U-phase, V-phase, or W-phase, in the third exemplary embodiment. With the coil component set 23′ shown in FIG. 22, two coil components 22 and 22′ are disposed in the radial direction. The coil component 22 is disposed on the outside in the radial direction, while the coil component 22′ is disposed on the inside in the radial direction.

With the coil component 22, the horizontal section 302c is formed on the conductor segment 300 disposed on the inside in the radial direction so as to go toward the vertical section 202b of the conductor segment 200 disposed on the outside in the radial direction.

As shown in FIG. 22, with the coil component 22′, a horizontal section 202c is formed from the distal end of the vertical section 202b of a conductor segment 200′ in the inward radial direction R1. No horizontal section 302c is formed on the conductor segment 300′ from the distal end of the vertical section 302b. The first face 9a of the horizontal section 202c of the conductor segment 200′ and the first face 9a of the vertical section 302b of the conductor segment 300′ are joined opposite each other. Thus, the horizontal section 202c is formed on the conductor segment 200′ disposed on the outside in the radial direction, so as to go toward the vertical section 302b of the conductor segment 300′ disposed on the inside in the radial direction.

We will now describe the welding performed with this layout of conductor segments 200, 200′, 300, and 300′.

With the layout of the conductor segments 200, 200′, 300, and 300′ shown in FIG. 22, TIG welding can be performed on the inside and outside in the radial direction.

In FIG. 22, a joint 41 produced by TIG welding between the conductor segment 200 and the conductor segment 300 is indicated by hatching. The joint 41 is formed so as to join the upper part of the end face 302d that faces in the outward radial direction R2 of the horizontal section 302c of the conductor segment 300, and the upper part of the second face 9b that faces in the outward radial direction of the vertical section 202b of the conductor segment 200.

In FIG. 22, a joint 42 produced by TIG welding between the conductor segment 200′ and the conductor segment 300′ is indicated by hatching.

The joint 42 is formed so as to join the upper part of the end face 202d that faces in the inward radial direction R1 of the horizontal section 202c of the conductor segment 200′, and the upper to part of the second face 9b that faces in the inward radial direction R1 of the vertical section 302b of the conductor segment 300′.

FIG. 23 shows the state when the joint 41 shown in FIG. 22 is welded. As shown in FIG. 23, there are a plurality of welding sites 801 at which the joint 41 is formed, provided facing outward in the radial direction. Wedge-shaped welding electrodes 701 are inserted between these welding sites 801 just as in the first exemplary embodiment. Since a plurality of the welding sites 801 are disposed between the two welding electrodes 701, the wedges 704 are inserted into the gaps between the welding electrodes 701. The welding torch 703 differs from the first exemplary embodiment in that it is disposed very close and diagonally above the welding sites 801 on the outside in the radial direction.

When TIG welding is performed in this state, joints 41 (see FIG. 22) that join the conductor segments 200 and the conductor segments 300 are formed at the welding sites 801.

Welding sites 802 where the conductor segments 200′ and the conductor segments 300′ are to be joined are provided on the inside in the radial direction, so in the welding, the welding torch 703 is disposed close to and diagonally above the welding sites 802 on the inside in the radial direction. When TIG welding is performed with the welding torch 703 thus disposed, joints 42 (see FIG. 22) are formed that join the conductor segments 200′ to the conductor segments 300′.

In the above description, the upper side of the stator 2 was described, but the lower side has the same configuration. No horizontal section 303c is formed on the conductor segment 300′, and a horizontal section is formed from the vertical section 203b of the conductor segment 200′ to the vertical section 303b of the conductor segment 300′.

Thus forming the joints 41 and 42 on the inside and outside in the radial direction allows the overall height of the stator 2 to be lower than when the joints are formed in the up and down direction of the stator 2 as in the first exemplary embodiment.

2. Main Features

The first exemplary embodiment also has the following features.

With the stator 2 in the third exemplary embodiment, the horizontal section 202c (an example of an end) of the conductor segment 200′ of the second (an example of the (i+1)-th) conductor segment 200′ counting from the inside is bent toward the vertical section 302b (an example of an end) of the first (an example of the i-th) conductor segment 300′ so that the second face 9b curves, and is joined to the vertical section 302b of the first (an example of the i-th) conductor segment 300′. The horizontal section 302c (an example of an end) of the third (an example of the (i+2)-th) conductor segment 300 is bent outward toward the vertical section 202b (an example of an end) of the fourth (an example of the (i+3)-th) conductor segment 200, and is joined to the vertical section 202b of the fourth (an example of the (i+3)-th) conductor segment 200.

With this configuration, the welding of the first conductor segment 300′ and the second conductor segment 200′ can be performed from the inside in the radial direction of the stator core 10, and the welding of the third conductor segment 300 and the fourth conductor segment 200 can be performed from the outside in the radial direction of the stator core 10.

Since the welded portions can be formed on the inside and outside in the radial direction of the stator, the welded portions are not formed above and below the stator as in the first exemplary embodiment, so the overall height of the stator can be kept low.

### Other Exemplary Embodiments

(A)

In the first to third exemplary embodiments above, the opposing first faces 9a of the vertical sections 202b and 203b of the conductor segments 200 and the horizontal sections 302c and 303c of the conductor segments 300 are flat, but a step may be formed at the horizontal sections 302c and 303c.

FIG. 24A shows a configuration in which a step 901a is formed on the first face 9a of the horizontal section 302c of the conductor segment 300. As shown in FIG. 24A, a step is formed on the first face 9a of the horizontal section 302c of the conductor segment 300, and a stepped face 901a is formed perpendicular to the upper end face 10a when mounted to the stator core 10. This stepped face 901a is provided over the entire width W 1 of the first face 9a (see FIG. 6B). The width of the second face 9b of the rectangular wire 9 is constant from the distal end of the horizontal section 302c up to the portion where the stepped face 901a is formed, but this width is less than W2 (see FIG. 6B).

FIG. 24B shows the state when the vertical section 202b of the conductor segment 200 has been put together with the horizontal section 302c in FIG. 24A. As shown in FIG. 24B, the to conductor segment 200 and the conductor segment 300 are put together so that the second face 9b on the inside of the vertical section 202b of the conductor segment 200 hits the stepped face 901a.

A step 901 is formed on the first face 9a at the end of the i-th conductor segment 300 so as to reduce the width of the second face 9b. The stepped face 901a formed perpendicular to the first face 9a by the step 901 is disposed perpendicular to the radial direction, and the second face 9b on the inside of the (i+1)-th conductor segment 200 hits the stepped face 901a.

FIG. 24C is a plan view of FIG. 24B, and illustrates the welding state. As shown in FIG. 24C, when the wedge-shaped welding electrodes 701 are inserted from the outer peripheral face 10d side, the vertical section 202b and the horizontal section 302c are pushed in the inward radial direction R1. At this point, the second face 9b on the inside of the vertical section 202b is pressed against the stepped face 901a, so the vertical section 202b and the horizontal section 302c can be welded in a state of being more reliably in contact. The step 901 plays the role of a stopper when the (i+1)-th conductor segment 200 moves to the inside.

(B)

In the first and second exemplary embodiments above, the horizontal sections 302c and 303c (examples of an end) of the i-th conductor segment 300 are bent outward toward the vertical sections 202b and 230b (examples of an end) of the (i+1)-th conductor segment 200 so that their second faces 9b curved, and are joined to the vertical sections 202b and 203b of the (i+1)-th conductor segment 200, but the vertical sections may be formed on the (i+1)-th conductor segment 200 toward the inside, and joined to the vertical sections of the i-th conductor segment 300 on which no horizontal sections have been formed.

In the first and second exemplary embodiments above, the conductor segment 300 located to the inside in the radial direction R (in the inward radial direction R1) may extend toward the outside (in the outward radial direction R2), and the conductor segment 200 located to the outside of the radial direction R may extend toward the inside and be joined with the conductor segment 300 on the inside in the radial direction R.

More specifically, as shown in FIG. 25A, the horizontal section 202c is formed in the inward radial direction R1 from the distal end of the vertical section 202b of the conductor segment 200′. No horizontal section 302c is formed on the conductor segment 300′ from the distal end of the vertical section 302b. The first faces 9a of the horizontal section 202c and the vertical section 302b are joined opposite each other.

(C)

As shown in FIG. 25B, a conductor segment 200′ on which the horizontal section 202c has been formed may be joined to a conductor segment 300 on which the horizontal section 302c has been formed. The horizontal section 202c and the horizontal section 302c are joined with their first faces 9a opposite each other.

(D)

As shown in FIG. 13, in the above exemplary embodiments, the first face 9a of the i-th conductor segment 300 on the slot 11 side where the the (i+1)-th conductor segment 200 is disposed (indicated by P1 in parentheses in FIG. 13), and the first face 9a (P2) of the (i+1)-th conductor segment 200 on the slot 11 side where the i-th conductor segment 300 is disposed are joined opposite each other, but this is not the only option. For instance, as shown in FIG. 26, the first face 9a on the opposite side of the i-th conductor segment 300 from the slot 11 where the (i+1)-th conductor segment 200 is disposed (indicated by P3 in parentheses in FIG. 26), and the first face 9a on the opposite side of the (i+1)-th conductor segment 200 from the slot 11 where the i-th conductor segment 300 is disposed (indicated by P4 in parentheses in FIG. 26) may be joined opposite each other.

(E)

In the first exemplary embodiment above, a total of six conductor segments 200 and 300 are disposed in a single slot 11, but the number is not limited to six. In the second and third exemplary embodiments above, a total of four conductor segments are disposed in a single slot 11, but the number is not limited to four.

(F)

In the above exemplary embodiments, the dynamo-electric machine 1 equipped with the stator 2 is used to drive the swing machinery 100, but this is not limited to the swing machinery 100. For example, it may be used as a drive motor for the travel of a lower traveling unit. In this case, the dynamo-electric machine 1 may be disposed so that its center axis A is horizontal.

The stator and the dynamo-electric machine equipped with this stator in the exemplary embodiments of the present invention allow sufficient joint strength to be ensured even when the portions to be joined at close together, and are useful in drive motors and the like used for travel and in the swing machinery of work vehicles.

Listing of claims:

1. A stator, comprising:
a cylindrical stator core having a plurality of slots formed in a radial direction on its inside; and
a coil having a plurality of conductor segments disposed in the plurality of slots and is formed by joining ends of the plurality of conductor segments,
the plurality of conductor segments being formed by rectangular wires that are rectangular in cross section and have a wide first face and a narrow second face, and being disposed in the plurality of slots so that the first faces are parallel to the radial direction,
a plurality of the conductor segments being disposed in the slots so that the respective second faces are opposite each other,
the conductor segment disposed at the i-th (where i is an integer greater than or equal to 1) position from the inside of the stator core being joined to the conductor segment disposed at the (i+1)-th position in another slot such that the first faces are opposite each other at the respective ends,
the joined opposing first faces being formed parallel to the radial direction,
the plurality of conductor segments having in-slot portions disposed in the slots, first protrusions that protrude from a first end face out of two end faces of the stator core, and second protrusions that protrude from a second end face out of the two end faces,
the ends being provided to both the first protrusions and the second protrusions, and
the joined opposing first faces being provided on both the first protrusion side and the second protrusion side.

2. The stator according to claim 1, wherein
the end of the i-th conductor segment is joined to the end of the (i+1)-th conductor segment by being bent outward toward the end of the (i+1)-th conductor segment so that the second face curves.

3. The stator according to claim 1, wherein
the opposing first faces are the first face of the i-th conductor segment on the slot side where the (i+1)-th conductor segment is disposed, and the first face of the (i+1)-th conductor segment on the slot side where the i-th conductor segment is disposed.

4. The stator according to claim 3, wherein
a step is formed at the first face at the end of the i-th conductor segment so that the second face is narrower, and
a step face formed perpendicular to the first face by the step is disposed perpendicular to the radial direction, and the second face on the inside of the (i+1)-th conductor segment hits the step face.

5. The stator according to claim 1, wherein
four or more of the conductor segments are disposed in each of the slots so that the second faces are opposite each other, and
a plurality of the joined opposing first faces are disposed in the radial direction.

6. The stator according to claim 1, wherein
a gap is formed between the first protrusion of the i-th conductor segment and the first protrusion of the (i+1)-th conductor segment, as viewed in a peripheral direction of the stator core, and
a gap is formed between the second protrusion of the i-th conductor segment and the second protrusion of the (i+1)-th conductor segment, as viewed in the peripheral direction.

7. The stator according to claim 1, wherein
the end of the (i+1)-th conductor segment is bent inward toward the end of the i-th conductor segment so that the second face curves, and is joined to the end of the i-th conductor segment, and
the end of the (i+2)-th conductor segment is bent outward toward the end of the (i+3)-th conductor segment so that the second face curves, and is joined to the end of the (i+3)-th conductor segment.

8. A dynamo-electric machine, comprising:
the stator according to claim 1; and
a rotor disposed on the inside of the stator.

9. The stator according to claim 2, wherein
the opposing first faces are the first face of the i-th conductor segment on the slot side where the (i+1)-th conductor segment is disposed, and the first face of the (i+1)-th conductor segment on the slot side where the i-th conductor segment is disposed.

10. The stator according to claim 9, wherein
a step is formed at the first face at the end of the i-th conductor segment so that the second face is narrower, and
the step face formed perpendicular to the first face by the step is disposed perpendicular to the radial direction, and the second face on the inside of the (i+1)-th conductor segment hits the step face.

11. A dynamo-electric machine, comprising:
the stator according to claim 2; and
a rotor disposed on the inside of the stator.

12. A dynamo-electric machine, comprising:
the stator according to claim 3; and
a rotor disposed on the inside of the stator.

13. A dynamo-electric machine, comprising:
the stator according to claim 4; and
a rotor disposed on the inside of the stator.

14. A dynamo-electric machine, comprising:
the stator according to claim 5; and
a rotor disposed on the inside of the stator.

15. A dynamo-electric machine, comprising:
the stator according to claim 6; and
a rotor disposed on the inside of the stator.

16. A dynamo-electric machine, comprising:
the stator according to claim 7; and
a rotor disposed on the inside of the stator.
